(19) United States
(12) Patent Application Publication
(10) Pub. No.: US 2022/0159565 A1
(43) Pub. Date: May 19, 2022

(54) METHOD AND APPARATUS FOR NODE SELECTION IN INTEGRATED ACCESS AND BACKHAUL NETWORK

(71) Applicants: SHARP KABUSHIKI KAISHA, Sakai City, Osaka (JP); FG Innovation Company Limited, Tuen Mun, New Territories (GB)

(72) Inventors: Kenneth James Park, Vancouver, WA (US); Atsushi ISHII, Vancouver, WA (US)

(21) Appl. No.: 17/437,815

(22) PCT Filed: Mar. 10, 2020
(86) PCT No.: PCT/JP2020/010261

§ 371 Date: Sep. 9, 2021

Related U.S. Application Data
(60) Provisional application No. 62/817,964, filed on Mar. 13, 2019.

(51) Int. Cl. H04W 48/20; H04W 48/08

(52) U.S. Cl. CPC H04W 48/20; H04W 48/08

(57) ABSTRACT

A wireless terminal (30) comprises receiver circuitry (94) and processor circuitry (70). The receiver circuitry (94) is configured to obtain quality of service information broadcast by base station apparatus (24). The processor circuitry (70) is configured to obtain a quality of service parameter requested for a connection to the radio access network, and to use the quality of service information broadcast by the base station apparatus and the quality of the service parameter requested for the connection to determine whether to attach to the base station apparatus.

### TECHNICAL FIELD

The technology relates to wireless communications, and particularly to methods, apparatus, and techniques for requesting, transmitting, updating, and using system information (SI) in wireless communications.

### BACKGROUND ART

In wireless communication systems, a radio access network generally comprises one or more access nodes (such as a base station) which communicate on radio channels over a radio or air interface with plural wireless terminals. In some technologies such a wireless terminal is also called a User Equipment (UE). A group known as the 3rd Generation Partnership Project (“3GPP”) has undertaken to define globally applicable technical specifications and technical reports for present and future generation wireless communication systems. The 3GPP Long Term Evolution (“LTE”) and 3GPP LTE Advanced (LTE-A) are projects to improve an earlier Universal Mobile Telecommunications System (“UMTS”) mobile phone or device standard in a manner to cope with future requirements.

In typical cellular mobile communication systems, the base station broadcasts on the radio channels certain information which is required for mobile stations to access to the network. In Long-Term Evolution (LTE) and LTE Advanced (LTE-A), such information is called “system information” (“SI”). Each access node, such as an evolved NodeB (“eNB”) or a gNB in the 5G New Radio (NR) System, broadcasts such system information to its coverage area via a Master Information Block (MIB) and several System Information Blocks (SIBs) on downlink radio resources allocated to the access node.

User Equipment (UE), after entering a coverage area of a gNB, is required to obtain all the necessary MIB/SIBs to access to the 5G cellular mobile communication system. At a minimum, the UE must acquire from the gNB broadcast the MIB and a particular SIB known as SIB1 to access the gNB, and ultimately the 5G Next Generation Core, NGC. For sake of UEs under the RF coverage area of a gNB, the gNB may broadcast all MIB/SIB s at periodic intervals, where the MIB and SIB1 are transmitted in a designated radio resource(s) with its own pre-determined periodicity, and the remaining SIBs are transmitted in a designated radio resources with its own configured periodicity as defined by content of the SIB 1. Alternately, the gNB may broadcast only the MIB and a sub-set of the SIBs, and the remainder of the SIBs that are not currently begin broadcast at the configured periodicity are obtained by the UE via a protocol exchange known as a “Request for on demand system information”. When the UE makes a request for on demand system information, and the gNB accepts that request, the gNB will begin to broadcast the SIBs requested by the UE, in designated radio resource(s) with its own configured periodicity as defined in the SIB 1.

For 3GPP Rel-16, the 5G architecture is expected to support the concept of Integrated Access and Backhaul (IAB) to transport data between 3GPP Relay Nodes, also known as IAB Nodes, via a wireless connection that uses/shares the same RF resources as a UE. RANI has completed a Technical Study on IAB and captured results in 3GPP TR 38.874 V16.0.0 (2018 December) 3rd Generation Partnership Project; Technical Specification Group Radio Access Network; NR; Study on Integrated Access and Backhaul; (Release 16), incorporated herein by reference. FIG. 1 shows one example of a 3GPP architecture that employs IAB Nodes, whereby such IAB Nodes provide for a multi-hop relay connection between a UE and the IAB Donor node, and ultimately a connection to the 5G Next Generation Core, NGC.

In 3GPP TR 38.874 the number of IAB Nodes that are linked together, and that ultimately link back to the original IAB Donor (aka gNB) is not restricted. Moreover, the number of UEs that may attached to the IAB Node is also not restricted. The number of links and the number of UEs may be dynamic. Thus the resources that are available for use by a UE attached to an IAB Node that is hierarchically further from the IAB Donor may be significantly less than a UE attached to an IAB Node that is hierarchically closer to the IAB Donor. A UE may be hierarchically further from the IAB Donor in the sense that there may be multiple IAB nodes between the gNB and the UE. With the available services thus potentially varying in view of hierarchical distance/number of links relative to the IAB Donor node, a UE may encounter inefficiency if not an unworkable situation upon connection attempt. For example, if a UE must always make a full connection back to the NGC only to find that the connection provided by the IAB Node is not sufficient to meet the UE's requirements, then that effort by the UE and IAB Node is a waste of both UE and system resource.

What is needed, therefore, and an example object of the technology disclosed herein, are methods, apparatus, and techniques for enabling a UE to ascertain in advance whether attachment, and subsequent connection, to a particular IAB node would be worthwhile.

### SUMMARY OF INVENTION

In one example, a base station apparatus of a radio access network comprising: processor circuitry configured to provide system information including quality of service information describing a quality of service offered by the base station apparatus; transmitter circuitry configured to transmit the system information over a radio interface to a wireless terminal to enable the wireless terminal to use the quality of service information to determine whether to attach to the base station apparatus.

In one example, a method in a base station apparatus of a radio access network comprising: providing system information including quality of service information describing a quality of service offered by the base station apparatus; transmitting the system information over a radio interface to a wireless terminal to enable the wireless terminal to use the quality of service information to determine whether to attach to the base station apparatus.

In one example, a wireless terminal which communicates with a base station apparatus of a radio access network across a radio interface, the wireless terminal comprising: receiver circuitry configured to obtain quality of service information broadcast by the base station apparatus; processor circuitry configured: to obtain a quality of service parameter requested for a connection to the radio access network; to use the quality of service information broadcast by the base station apparatus and the quality of the service parameter requested for the connection to determine whether to attach to the base station apparatus.

In one example, a method in a wireless terminal which communicates with a base station apparatus of a radio access network across a radio interface, the method comprising: obtaining quality of service information broadcast by the base station apparatus; obtaining a quality of service parameter requested for a connection to the radio access network; using the quality of service information broadcast by the base station apparatus and the quality of the service parameter requested for the connection to determine whether to attach to the base station apparatus.

### BRIEF DESCRIPTION OF DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a diagrammatic view showing an example Integrated Access and Backhaul (IAB) network.

FIG. 2 is a diagrammatic view showing transition states of a Radio Resource Control RRC state machine.

FIG. 3 is a schematic view showing an example generic communications system comprising a radio access node and a wireless terminal, wherein the radio access node broadcasts system information including node quality of service information to the wireless terminal so that the wireless terminal can determine whether to attach to the radio access node.

FIG. 4 is a flowchart showing example, basic example acts or steps performed by a base station or radio access node of the example generic communications system of FIG. 3.

FIG. 5 is a flowchart showing example, basic example acts or steps performed by a wireless terminal or UE of the example generic communications system of FIG. 3.

FIG. 6 is a diagrammatic view generically showing system information broadcast from an IAB node as including IAB node quality of service information.

FIG. 7 is a flowchart showing more detail and/or different aspects of operation of a wireless terminal according to a first example embodiment and mode.

FIG. 8 is a diagrammatic view showing in more detail an example, non-limiting format of SIB Type 1 broadcast from an IAB node.

FIG. 9 is a diagrammatic view showing a hierarchal description of some of the elements of a system information block (SIB) that includes IAB node quality of service information.

FIG. 10 is a flowchart showing example, basic, representative acts or steps that, in an example implementation, may be involved in executing acts of FIG. 7.

FIG. 11 is a flowchart showing more detail and/or different aspects of operation of a wireless terminal according to a second example embodiment and mode.

FIG. 12 is a diagrammatic view of an example format of SystemInformationBlockType1 comprising 5QIInfoList according to an example embodiment and mode.

FIG. 13 is a diagrammatic view of an example format of a Master Information Block (MIB) comprising 5QIInfoList according to an example embodiment and mode.

FIG. 14 is a flowchart showing example, basic, representative acts or steps that, in an example implementation, may be involved in executing acts of FIG. 11.

FIG. 15 is a diagrammatic view showing example electronic machinery which may comprise node electronic machinery or terminal electronic machinery.

### DESCRIPTION OF EMBODIMENTS

In one of its example aspects the technology disclosed herein concerns a base station apparatus of a radio access network, and method of operating same. The base station apparatus comprises processor circuitry and transmitter circuitry. The processor circuitry is configured to provide system information including quality of service information describing a quality of service offered by the base station apparatus. The transmitter circuitry is configured to transmit the system information over a radio interface to a wireless terminal to enable the wireless terminal to use the quality of service information to determine whether to attach to the base station apparatus.

In another of its example aspects the technology disclosed herein concerns a wireless terminal which communicates with a base station apparatus of a radio access network across a radio interface and method of operating same. The wireless terminal comprises receiver circuitry and processor circuitry. The receiver circuitry is configured to obtain quality of service information broadcast by the base station apparatus. The processor circuitry is configured to obtain a quality of service parameter requested for a connection to the radio access network, and to use the quality of service information broadcast by the base station apparatus and the quality of the service parameter requested for the connection to determine whether to attach to the base station apparatus.

In the following description, for purposes of explanation and not limitation, specific details are set forth such as particular architectures, interfaces, techniques, etc. in order to provide a thorough understanding of the technology disclosed herein. However, it will be apparent to those skilled in the art that the technology disclosed herein may be practiced in other embodiments that depart from these specific details. That is, those skilled in the art will be able to devise various arrangements which, although not explicitly described or shown herein, embody the principles of the technology disclosed herein and are included within its spirit and scope. In some instances, detailed descriptions of well-known devices, circuits, and methods are omitted so as not to obscure the description of the technology disclosed herein with unnecessary detail. All statements herein reciting principles, aspects, and embodiments of the technology disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudocode, and the like represent various processes which may be substantially represented in computer readable medium and so executed by a computer or processor, whether or not such computer or processor is explicitly shown.

As used herein, the term “core network” can refer to a device, group of devices, or sub-system in a telecommunication network that provides services to users of the telecommunications network. Examples of services provided by a core network include aggregation, authentication, call switching, service invocation, gateways to other networks, etc.

As used herein, the term “wireless terminal” can refer to any electronic device used to communicate voice and/or data via a telecommunications system, such as (but not limited to) a cellular network. Other terminology used to refer to wireless terminals and non-limiting examples of such devices can include user equipment terminal, UE, mobile station, mobile device, access terminal, subscriber station, mobile terminal, remote station, user terminal, terminal, subscriber unit, cellular phones, smart phones, personal digital assistants (“PDAs”), laptop computers, netbooks, e-readers, wireless modems, etc.

As used herein, the term “access node”, “node”, or “base station” can refer to any device or group of devices that facilitates wireless communication or otherwise provides an interface between a wireless terminal and a telecommunications system. A non-limiting example of a base station can include, in the 3GPP specification, a Node B (“NB”), an enhanced Node B (“eNB”), a home eNB (“HeNB”), a 5G (New Radio [NR]) gNB, or some other similar terminology. Another non-limiting example of a base station is an access point. An access point may be an electronic device that provides access for wireless terminal to a data network, such as (but not limited to) a Local Area Network (“LAN”), Wide Area Network (“WAN”), the Internet, etc. Although some examples of the systems and methods disclosed herein may be described in relation to given standards (e.g., 3GPP Releases 8, 9, 10, 11, 12, or higher), the scope of the present disclosure should not be limited in this regard. At least some aspects of the systems and methods disclosed herein may be utilized in other types of wireless communication systems.

As used herein, the term “telecommunication system” or “communications system” can refer to any network of devices used to transmit information. A non-limiting example of a telecommunication system is a cellular network or other wireless communication system.

As used herein, the term “cellular network” can refer to a network distributed over cells, each cell served by at least one fixed-location transceiver, such as a base station. A “cell” may be any communication channel that is specified by standardization or regulatory bodies to be used for International Mobile Telecommunications-Advanced (“IMTAdvanced”). All or a subset of the cell may be adopted by 3GPP as licensed bands (e.g., frequency band) to be used for communication between a base station, such as a Node B, and a UE terminal. A cellular network using licensed frequency bands can include configured cells. Configured cells can include cells of which a UE terminal is aware and in which it is allowed by a base station to transmit or receive information.

As used herein, “system information” (“SI”) may include a Master Information Block (MIB) and several System Information Blocks (SIBs) which are provided on downlink radio resources allocated to a access node. The system information may be broadcast, and some types of system information may be provided on demand, e.g., upon receipt of a request for system information from a wireless terminal.

In various aspects of the technology disclosed herein, system information is classified into plural categories or types. In an example embodiment and mode, a first type of the system information is Minimum System Information (Minimum SI), minimally containing information required for UEs initially access to the network, periodically broadcasted by each access node (e.g. eNB for LTE, gNB for 5G Radio System). In some configurations, Minimum System SI may consist of MIB and a limited number of SIBs. The Minimum SI may be also referred as “essential SI”, or first type system information.

A second type of system information, e.g., “Other system information, “Other SI”, or second type system information contains all the other types of information, i.e., all types of system information except the Minimum System Information. The Other SI may comprise several system information blocks (SIBs) that are not categorized as Minimum SI. The Other SI may be also referred as “non-essential SI”. However, the second type system information is not to be confused with SIB Type 2, which is a particular (second) system information block (SIB) that may be included in the Minimum System Information.

In some example embodiment and modes described herein, for each of the SIBs belongings to Other SI, the access node may choose to broadcast the SIB periodically, similar to the SIBs in Minimum SI. Alternatively, the access node may choose to refrain from transmitting the SIB until receiving a request of on-demand delivery from a UE. In this case, the access node may advertise the availability of on-demand delivery using Minimum SI.

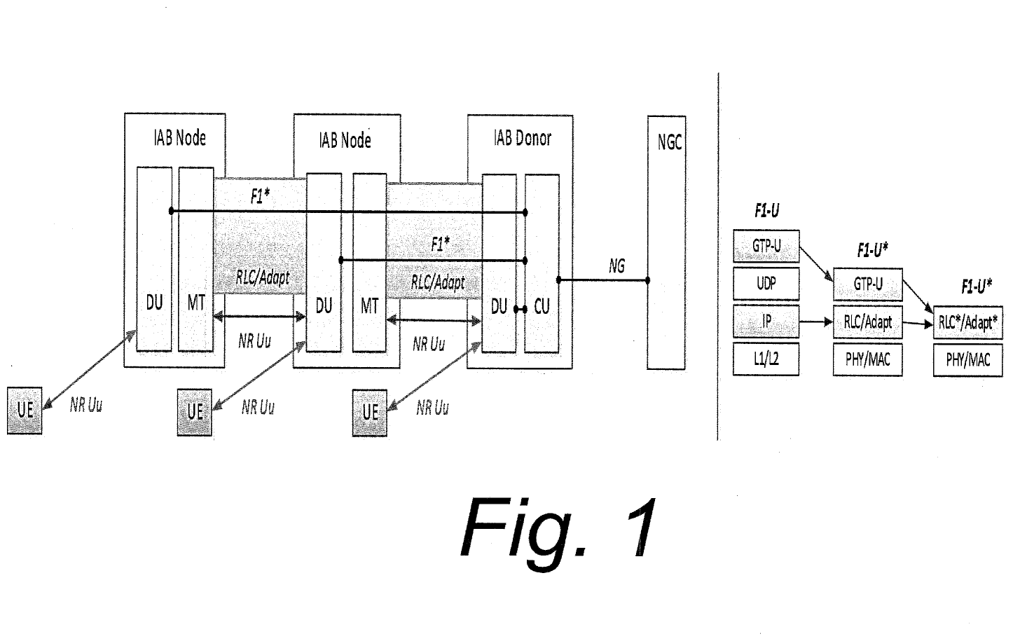

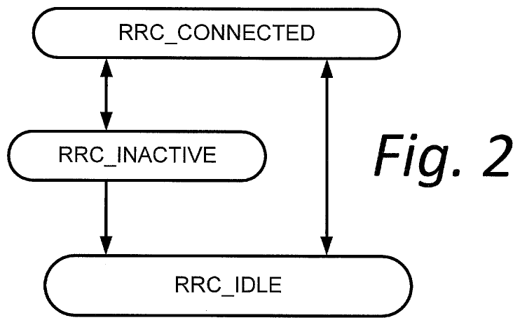

As described herein, both an access node and a wireless terminal may manage respective Radio Resource Control (RRC) state machines. The RRC state machines transition between several RRC states including RRC_IDLE, RRC_INACTIVE and RRC_CONNECTED. FIG. 1 depicts the state transition diagram of the RRC states. From the vantage point of a wireless terminal e.g., user equipment (UE), the RRC states may be briefly characterized as follows:

RRC_IDLE:
A UE specific DRX (discontinuous reception) may be configured by upper layers;
UE controlled mobility based on network configuration;
The UE:
   Monitors a Paging channel;
   Performs neighboring cell measurements and cell (re-)selection;
   Acquires system information.

RRC_INACTIVE:
A UE specific DRX may be configured by upper layers or by RRC layer;
UE controlled mobility based on network configuration;
The UE stores the Access Stratum (AS) context;
The UE:
   Monitors a Paging channel;
   Performs neighboring cell measurements and cell (re-)selection;
   Performs RAN-based notification area updates when moving outside the RAN-based notification area;
   Acquires system information.

RRC_CONNECTED:
The UE stores the AS context.
Transfer of unicast data to/from UE.
At lower layers, the UE may be configured with a UE specific DRX;
Network controlled mobility, i.e. handover within NR and to/from E-UTRAN.;
The LTE:
   Monitors a Paging channel;
   Monitors control channels associated with the shared data channel to determine if data is scheduled for it;
   Provides channel quality and feedback information;
   Performs neighboring cell measurements and measurement reporting;
   Acquires system information.

The technology disclosed herein concerns, e.g., apparatus, methods, and procedures for determining when to attempt to attach via an IAB node to a core network, in view of capabilities of the IAB node. In an attachment procedure, a wireless terminal registers with the core network, through the radio access network, to receive service(s) that require registration. Aspects of an LTE attachment procedure is described in 3GPP TS 23.401, which is incorporated herein by reference. The technology disclosed herein provides, e.g., pre-attachment insight regarding feasibility of attachment and successful connection to the core network through the IAB node. Such pre-attachment insight may be based on broadcasted capabilities or characteristics of the IAB node, such as quality of service information offered by the IAB node.

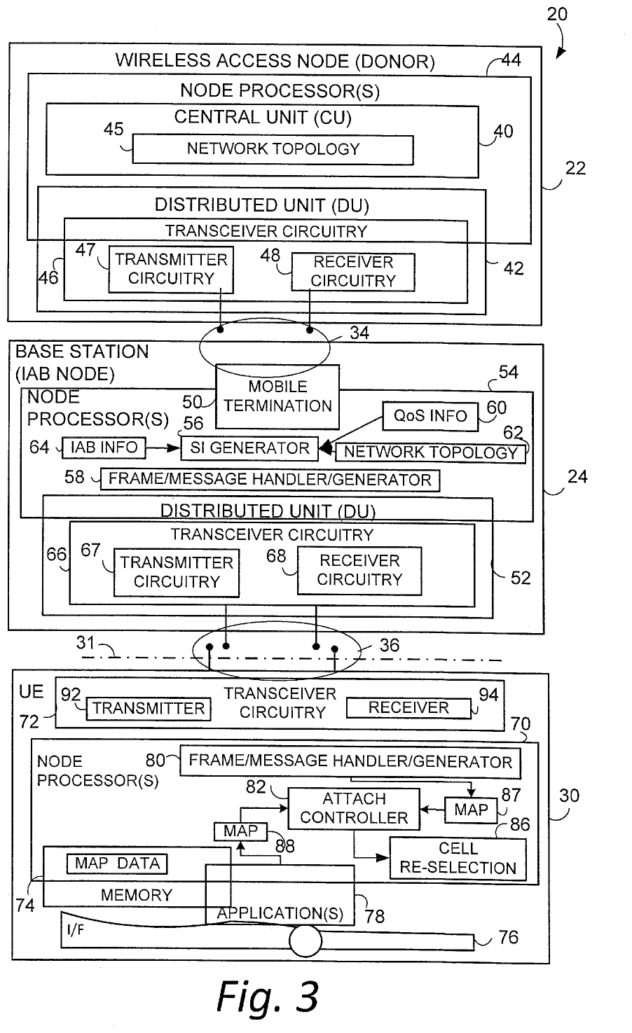

FIG. 3 shows a portions of a telecommunications system 20, e.g., an Integrated Access and Backhaul (IAB) radio access network, which includes wireless access node 22, also known as a donor IAB node 22 or simply as donor node 22; base station node 24, also known as IAB-node 24 or relay node 24; and IAB node 30, also known UE 30 or as child node 30. The child node 30 may be, for example, a wireless terminal, mobile station, or user equipment, UE, as previously explained, or an Integrated Access and Backhaul (IAB) node, as previously described. The IAB-node 24 and the user equipment (UE) 30 communicate over a radio or air interface 31. The donor IAB node 22 may be connected by a wired backhaul link to another wireless access donor node, which in turn may be connected by wireless backhaul to other IAB nodes served by such other donor node. The donor IAB node 22 may be connected by wireless backhaul link 34 to IAB-node 24, and the IAB-node 24 may be connected by wireless backhaul link 36 to wireless terminal 30.

In some non-exclusive and non-limiting example embodiments and modes, the nodes shown in FIG. 3 may be implemented with “Network Function Virtualization” or NFV, as explained, for example, in 3GPP TS 38.913 and 3GPP TS 38.801. As such, the 5G New Radio, NR, may allow Centralized Unit (CU) deployment with Network Function virtualization (NFV). When shown with an optional NFV implementation, donor IAB node 22 may comprise donor node central unit 40 and donor node distributed unit 42. The donor node central unit 40 and donor node distributed unit 42 may be realized by, e.g., be comprised of or include, one or more processor circuits, e.g., donor node processor(s) 44. The one or more donor node processor(s) 44 may be shared by donor node central unit 40 and donor node distributed unit 42, or each of donor node central unit 40 and donor node distributed unit 42 may comprise one or more donor node processor(s) 44. Moreover, donor node central unit 40 and distributed unit donor node distributed unit 42 may be co-located at a same node site, or alternatively one or more donor node distributed units 42 may be located at sites remote from donor node central unit 40 and connected thereto by a packet network. The donor node central unit 40 may perform many donor node operations known to the person skilled in the art. One example function or sub-component of donor node central unit 40, shown in FIG. 3, is maintenance of a network topology information 45, which may be stored in a database accessed by donor node central unit 40.

The donor node distributed unit 42 may comprise donor node transceiver circuitry 46, which in turn may comprise donor node transmitter circuitry 47 and donor node circuitry 48. The donor node transceiver circuitry 46 includes antenna(e) for the wireless transmission. The node transmitter circuitry 47 includes, e.g., amplifier(s), modulation circuitry and other conventional transmission equipment. The donor node circuitry 48 comprises, e.g., amplifiers, demodulation circuitry, and other conventional receiver equipment.

The base station node 24 may comprise base station or IAB node mobile termination unit 50 and IAB node distributed unit 52. The IAB node mobile termination unit 50 facilitates communication over the backhaul link 34 with, e.g., donor IAB node 22. Portions of IAB node mobile termination unit 50 and IAB node distributed unit 52 may comprise or be realized by IAB node processor(s) 54.

FIG. 3 shows IAB node processor(s) 54 as comprising or working in conjunction with various units and/or functionalities pertinent to the IAB-node 24, including system information (SI) generator 56, frame/message generator/handler 58, quality of service controller 60, network topology controller 62, and IAB node identity information 64. As described herein, the system information generator 56 provides or generates system information which may be included in system information blocks (SIBs). The system information, e.g., in the form of system information blocks (SIBs), may be broadcast by base station node 24. The system information, e.g., system information blocks (SIBs), whether minimum SI or “other SI” as described herein, may be included in a frame or sub-frame of information transmitted by base station node 24.

At least some of the system information generated system information (SI) generator 56 and provided by the base station node 24 is Minimum System Information (Minimum SI), also known as first type system information. Some of the system information may be Other system information (Other SI), also known as second type system information. The wireless terminal 30 uses the system information (SI) generated by base station node 24. Some of the Minimum SI may inform the wireless terminal 30 of the availability of the Other SI. In some example implementations, upon knowing of the availability of the Other IS, the wireless terminal 30 specifically requests the Other system information, in on-demand fashion. Reference herein to “a second type system information block (SIB)”, or “a second type SIB”, means one or more pieces of Other system information (Other SI), e.g., one or more second type system information blocks (SIBs). In some example situations indeed only one second type SIB may be advertised as available and accordingly requested on-demand. But in other example situations plural second type SIBs (e.g., plural pieces of Other SI) are advertised as available and requested on-demand.

In general operation, base station node 24 and wireless terminal 30 communicate with each other across radio interface 31 using predefined configurations of information. By way of non-limiting example, the base station node 24 and wireless terminal 30 may communicate over radio interface 31 using “frames” of information that may be configured to include various channels. In Long Term Evolution (LTE), for example, a frame, which may have both downlink portion(s) and uplink portion(s), may comprise plural subframes, with each LTE subframe in turn being divided into two slots. The frame may be conceptualized as a resource grid (a two dimensional grid) comprised of resource elements (RE). Each column of the two dimensional grid represents a symbol (e.g., an OFDM symbol on downlink (DL) from node to wireless terminal; an SC-FDMA symbol in an uplink (UL) frame from wireless terminal to node). Each row of the grid represents a subcarrier. The frame and subframe structure serves only as an example of a technique of formatting of information that is to be transmitted over a radio or air interface. It should be understood that “frame” and “subframe” may be utilized interchangeably or may include or be realized by other units of information formatting, and as such may bear other terminology (such as blocks, for example). To cater to the transmission of information between base station node 24 and wireless terminal 30 over radio interface 31, the IAB node processor(s) 54 and wireless terminal processor(s) 70 of FIG. 3 are shown as comprising respective information handlers. For an example implementation in which the information is communicated via frames, the information handler for base station node 24 is shown as frame/message generator/handler 58, while the information handler for wireless terminal 30 is shown as frame/signal handler/generator 80.

The IAB node distributed unit 52 of base station node 24 may comprise or work in conjunction with base station transceiver circuitry 66, which in turn may comprise base station transmitter circuitry 67 and base station receiver circuitry 68. The base station transceiver circuitry 66 includes antenna(e) for the wireless transmission. The base station transmitter circuitry 67 may include, e.g., amplifier(s), modulation circuitry and other conventional transmission equipment. The base station receiver circuitry 68 may comprise, e.g., amplifiers, demodulation circuitry, and other conventional receiver equipment.

FIG. 3 shows wireless terminal 30 as comprising, in an example, non-limiting embodiment and mode, wireless terminal processor(s) circuitry 70, also known as wireless terminal processor(s) 70; wireless terminal transceiver circuitry 72; wireless terminal memory 74; and wireless terminal user interface(s) 76. The wireless terminal processor(s) 70 may execute one or more sets of instructions stored in wireless terminal memory 74 or otherwise accessible by wireless terminal processor(s) 70, including one or more executable applications 78. The wireless terminal user interface(s) 76 may serve for both user input and output operations, and may comprise (for example) a screen such as a touch screen that can both display information to the user and receive information entered by the user. The wireless terminal user interface(s) 76 may also include other types of devices, such as a speaker, a microphone, or a haptic feedback device, for example.

The wireless terminal processor(s) 70 comprises or executes functionalities including frame/signal handler/generator 80; attach controller 82; cell (re)selection controller 86; and mapping units 87 and 88. The frame/signal handler/generator 80 serves to handle messages, signals, and data received from other nodes, including but not limited to the system information broadcast from the IAB-node 24.

The wireless terminal transceiver circuitry 72 in turn may comprise terminal transmitter circuitry 92 and terminal receiver circuitry 94. The terminal transceiver circuitry 72 includes antenna(e) for the wireless transmission. The terminal transmitter circuitry 92 may include, e.g., amplifier(s), modulation circuitry and other conventional transmission equipment. The terminal receiver circuitry 94 may comprise, e.g., amplifiers, demodulation circuitry, and other conventional receiver equipment.

As an example aspect of the technology disclosed herein, the IAB Node, also known as base station node 24, needs to share with a UE 30 that is in IDLE or INACTIVE mode, e.g., camped on the IAB Node, the current quality of service, QoS, that the IAB Node can provide as well as any change in the QoS that the IAB Node is currently providing. One reason for sharing quality of service information is that (1) changes in the number of backhaul links and (2) the number of UEs supported by IAB Nodes that are hierarchically closer to the Donor IAB Node may impact the latency and the number of RF resources that the IAB Node can schedule for use by the UE to such an extent that the UE can no longer meet its requirements.

According to an example aspect of the technology disclosed herein, an IAB Node such as base station node 24 of FIG. 3 may share with a UE, and with other IAB Nodes that may attach as a Child IAB Node to a Parent IAB Node, the minimum QoS that the UE can expect to receive before the UE attaches to the 5GC via the IAB Node so that the UE can determine if the throughput, latency, priority levels, packet error rate, etc., e.g., the QoS, provided by the IAB Node are sufficient to support the needs of the UE.

In the example embodiment and mode of FIG. 3, base station node 24 comprises IAB node processor(s) 54 which provide system information including quality of service information describing a quality of service offered by base station node 24. The quality of service information may be stored at or generated by quality of service controller 60 and provided to system information (SI) generator 56. The system information provided or generated by system information (SI) generator 56 may then be included by system information (SI) generator 56 in a frame of information transmitted by base station transmitter circuitry 67. The base station transmitter circuitry 67 transmits the system information over radio interface 31 to wireless terminal 30 to enable the wireless terminal 30 to use the quality of service information to determine whether to attach to the base station node 24.

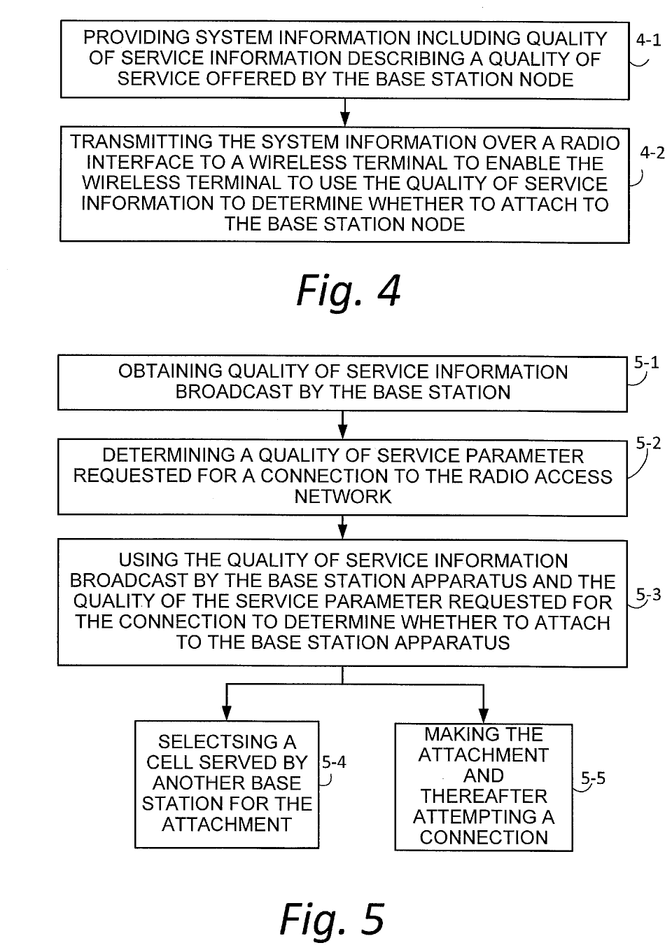

Basic, representative, example acts or steps performed by base station node 24 are shown in FIG. 4. Act 4-1 comprises providing system information including quality of service information describing a quality of service offered by the base station node 24. Act 4-2 comprises transmitting the system information over a radio interface to a wireless terminal to enable the wireless terminal, in an idle or disconnected mode, e.g., not in connected mode, to use the quality of service information to determine whether to attach to the base station node 24.

In the example embodiment and mode of FIG. 3, wireless terminal 30 comprises receiver circuitry 94 configured to obtain quality of service information broadcast by the base station 24 over the air or radio interface 31. The wireless terminal 30 further comprises wireless terminal processor(s) 70 which both (1) determines a quality of service parameter requested for a connection to the radio access network and (2) uses the quality of service information broadcast by the base station apparatus and the quality of the service parameter requested for the connection to determine whether to attach to the base station apparatus.

Basic, representative, example acts or steps performed by wireless terminal 30 are shown in FIG. 5. Act 5-1 comprises the wireless terminal, in an idle or disconnected mode, obtaining quality of service information broadcast by the base station. Act 5-2 comprises obtaining a quality of service parameter requested for a connection to the radio access network. The quality of service parameter may be requested, for example, by one of the applications 78 being executed at the wireless terminal 30. Act 5-3 comprises using the quality of service information broadcast by the base station apparatus and the quality of the service parameter requested for the connection to determine whether to attach to the base station apparatus. The determination of act 5-3 may be implemented, for example, by the attachment controller 82 making an evaluation or comparison of the quality of service information broadcast by the base station apparatus and the quality of the service parameter requested for the connection. In a case that the attachment controller 82 makes a determination that the quality of service information broadcast by the base station apparatus does not warrant attachment by the wireless terminal to the base station node 24, as act 5-4 the cell (re)selection controller 86 selects a cell served by another base station for the attachment. Alternatively, in a case that the attachment controller 82 makes a determination that the quality of service information broadcast by the base station apparatus does warrant attachment by the wireless terminal to the base station node 24, as act 5-4 the attachment controller 82 makes the attachment and any associated connection attempt. As used herein, “warrant attachment” means that when the wireless terminal wireless terminal is in idle or unconnected mode, the attachment controller 82 makes a determination that the quality of service offered by the base station node 24 is sufficient for the purpose for which the attach request and any associated connection attempt is to be made.

Although thus far reference has been made to quality of service information, it should be understood that such term may include one parameter or value, a set of parameters values, or plural sets of parameters or values. For example, and as explained further below, the quality of service information may comprise a code or value that represents a set of plural types of quality of service information, e.g., a set of plural values or descriptors. Moreover, the quality of service information may comprise plural such sets. For example, when including the quality of service information in broadcasted system information, e.g., in a system information block (SIB), the quality of service information may comprise plural sets of quality of service information, all of which may be available at or descriptive of the base station node 24. Conversely, when at act 5-2, for example, the wireless terminal 30 obtains a requested quality of service parameter or value, such parameter or value may comprise a set of parameters or values, or even plural sets of parameters of values, any of which, if matched or provided by the base station node 24, would be sufficient for the requested attachment and ensuing potential connection. In other words, the base station node 24 may broadcast quality of service information comprising plural levels of quality of service provided by base station node 24, which may be evaluated by attachment controller 82 against plural levels of requested quality of service.

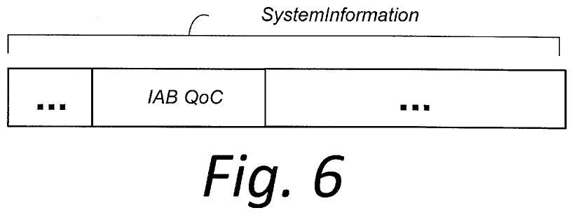

As one example aspect of the technology disclosed herein, a new Information Elements (IE) is defined or provided, and that new information element may be transmitted as part of the MIB/SIB broadcast of base station node 24 or IAB Node, acting as a gNB. This new information element, which may also be known as the quality of service QoS IE may provide an indication of the different levels of QoS, and the characteristics of each QoS level, that the IAB Node can provide. FIG. 6 basically shows in simplified form the system information (SI) broadcasted by base station node 24 as comprising IAB node quality of service IE, e.g., IAB QoS IE.

Rather than populating the new QoS IE with a large and complex set of parameters that define the different characteristics of each QoS level that the system can provide, in another of its example aspects the technology disclosed herein conserves Radio Frequency resources by sending one or more discrete values, e.g., a QoS Level, where each discrete value maps to a set of QoS characteristics. In an example implementation, for the purpose of defining the relationship between a discrete value and a set of QoS characteristic, the technology disclosed herein leverages, e.g., reuses, the standardized 5QI to QoS Characteristics mapping as defined in table 5.7.4-1 of 3GPP TS 24.301 V15.5.0 (2018-12; 3rd Generation Partnership Project; Technical Specification Group Core Network and Terminals; Non-Access-Stratum (NAS) protocol for Evolved Packet System (EPS); Stage 3 (Release 15), which is reproduced at least in part as Table 1 below. Table 1 specifies a one-to-one mapping of standardized 5QI values to 5G QoS Characteristics. Although the mapping of Table 1 is shown as an example, it should be understood that other mappings or conventions for abbreviating expression of the quality of service information may be employed. Thus, the QoS IE as broadcast in system information by base station node 24 provides a means for the UE, or child IAB Node, to obtain one or more QoS Levels without establishing a full connection to the new radio core network, e.g., NGC. By using the mapping of values, such as 5QI value, to QoS Levels, the IAB Node can indicate the QoS Characteristics provided by the IAB Node with a minimum overhead.

TABLE 1

| | | | | | Default | | |
|---|---|---|---|---|---|---|---|
| | | | | | Maximum | | |
| | | Default | Packet | Packet | Data Burst | Default | |
| 5QI | Resource | Priority | Delay | Error | Volume | Averaging | Example |
| Value | Type | Level | Budget | Rate | (NOTE 2) | Window | Services |
| 1 | GBR | 20 | 100 ms | 10⁻² | N/A | 2000 ms | Conversational |
| | | | | | | | Voice |
| 2 | | 40 | 150 ms | 10⁻³ | N/A | 2000 ms | Conversational |
| | | | | | | | Video (Live |
| | | | | | | | Streaming) |
| 3 | | 30 | 50 ms | 10⁻³ | N/A | 2000 ms | Real Time |
| | | | | | | | Gaming, V2X |
| | | | | | | | messages |
| | | | | | | | Electricity |
| | | | | | | | distribution - |
| | | | | | | | medium voltage, |
| | | | | | | | Process |
| | | | | | | | automation - |
| | | | | | | | monitoring |
| 4 | | 50 | 300 ms | 10⁻⁶ | N/A | 2000 ms | Non- |
| | | | | | | | Conversational |
| | | | | | | | Video |
| | | | | | | | (Buffered |
| | | | | | | | Streaming) |
| 65 | | 7 | 75 ms | 10⁻² | N/A | 2000 ms | Mission Critical |
| | | | | | | | user plane Push |
| | | | | | | | To Talk voice |
| | | | | | | | (e.g., MCPTT) |
| 66 | | 20 | 100 ms | 10⁻² | N/A | 2000 ms | Non-Mission- |
| | | | | | | | Critical user plane |
| | | | | | | | Push To Talk |
| | | | | | | | voice |
| 67 | | 15 | 100 ms | 10⁻³ | N/A | 2000 ms | Mission Critical |
| | | | | | | | Video user plane |
| 75 | | | | | | | |
| 5 | Non-GBR | 10 | 100 ms | 10⁻⁶ | N/A | N/A | IMS Signalling |
| 6 | | 60 | 300 ms | 10⁻⁶ | N/A | N/A | Video (Buffered |
| | | | | | | | Streaming) |
| | | | | | | | TCP-based (e.g., |
| | | | | | | | www, e-mail, |
| | | | | | | | chat, ftp, p2p file |
| | | | | | | | sharing, |
| | | | | | | | progressive |
| | | | | | | | video, etc.) |
| 7 | | 70 | 100 ms | 10⁻³ | N/A | N/A | Voice, |
| | | | | | | | Video (Live |
| | | | | | | | Streaming) |
| | | | | | | | Interactive |
| | | | | | | | Gaming |
| 8 | | 80 | 300 ms | 10⁻⁶ | N/A | N/A | Video (Buffered |
| 9 | | 90 | | | | | Streaming) |
| | | | | | | | TCP-based (e.g., |
| | | | | | | | www, e-mail, |
| | | | | | | | chat, ftp, p2p file |
| | | | | | | | sharing, |
| | | | | | | | progressive |
| | | | | | | | video, etc.) |
| 69 | | 5 | 60 ms | 10⁻⁶ | N/A | N/A | Mission Critical |
| | | | | | | | delay sensitive |
| | | | | | | | signalling (e.g., |
| | | | | | | | MC-PTT |
| | | | | | | | signalling) |
| 70 | | 55 | 200 ms | 10⁻⁶ | N/A | N/A | Mission Critical |
| | | | | | | | Data (e.g. |
| | | | | | | | example services |
| | | | | | | | are the same as |
| | | | | | | | 5QI 6/8/9) |
| 79 | | 65 | 50 ms | 10⁻² | N/A | N/A | V2X messages |
| 80 | | 68 | 10 ms | 10⁻⁶ | N/A | N/A | Low Latency |
| | | | | | | | eMBB |
| | | | | | | | applications |
| | | | | | | | Augmented |
| | | | | | | | Reality |
| 82 | Delay | 19 | 10 ms | 10⁻⁴ | 255 bytes | 2000 ms | Discrete |
| | Critical | | | | | | Automation (see |
| | GBR | | | | | | TS 22.261 [2]) |
| 83 | | 22 | 10 ms | 10⁻⁴ | 1354 bytes | 2000 ms | Discrete |
| | | | | | | | Automation (see |
| | | | | | | | TS 22.261 [2]) |
| 84 | | 24 | 30 ms | 10⁻⁵ | 1354 bytes | 2000 ms | Intelligent |
| | | | | | | | transport systems |
| | | | | | | | (see |
| | | | | | | | TS 22.261 [2]) |
| 85 | | 21 | 5 ms | 10⁻⁵ | 255 bytes | 2000 ms | Electricity |
| | | | (NOTE | | | | Distribution- |
| | | | 5) | | | | high voltage (see |
| | | | | | | | TS 22.261 [2]) |

As another of its example aspects, the technology disclosed herein leverages use of a data element areaScope that is associated with each SIB other than the SIB1 and MIB. The IE areaScope is utilized by the technology disclosed herein to further characterize the QoS IE that is being broadcast by the IAB Node. For example, by not setting the areaScope bit for the SIB (other than SIB1 and MIB) that is carrying the QoS IE, the IAB Node can inform the UE that the QoS Characteristics provided by the IAB Node are unique to the IAB Node, and alternately by setting the areaScope bit for the SIB (other than SIB1 and MIB) that is carrying the QoS IE, the IAB Node can inform the UE that the QoS Characteristics provided by the IAB Node are the same across all IAB Nodes defined by the IE known as systemInformationAreaID. Thus, a UE can determine that if the current SIB (other than SIB1 and MIB) that is carrying the QoS IE does not provide sufficient QoS, that there may be other IAB Nodes that do, and alternately that all IAB Nodes provide the same QoS Characteristics and thus to continue cell reselection in the current systemInformationAreaID will not result in a IAB Node with different (e.g. more suitable) QoS.

### First Example Embodiment

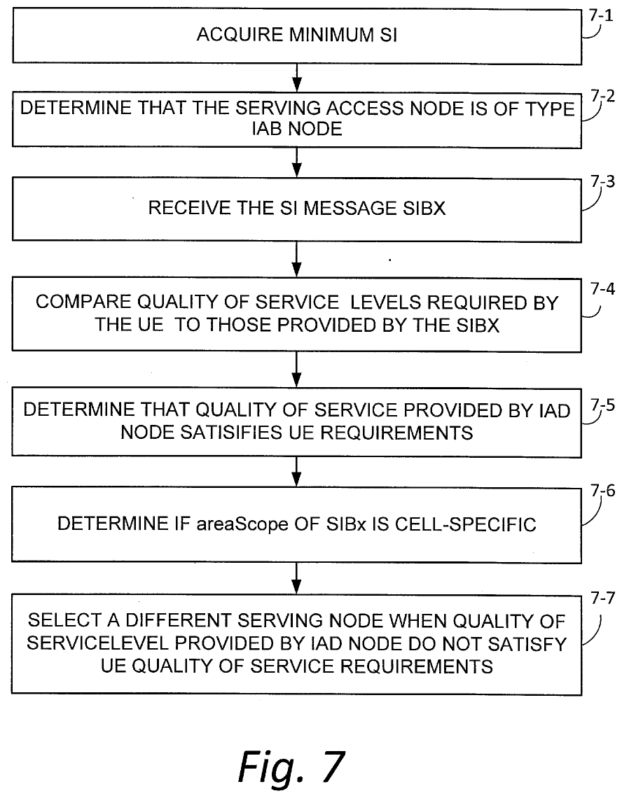

FIG. 7 shows a high-level flow of representative, example, basic acts or steps for a wireless terminal making a determination if an IAB Node, e.g., base station node 24, cannot provide the necessary QoS, and then making a determination if the wireless terminal should select a different IAB Node based on the setting of the areaScope parameter. The example embodiment and mode of FIG. 7 uses “Other SI” to carry the quality of service information which is broadcast by the base station node 24. It should be understood however, that the quality of service information may also be broadcast in the Minimum SI.

Act 7-1 comprises the wireless terminal receiving the Minimum SI that is broadcasted from the currently serving access node. The Minimum SI may contain information about the Other SI, including the delivery method, e.g., periodic broadcast/on-demand, scheduling information, validity information, areaScope, etc. Act 7-2 comprises the wireless terminal optionally determining, based on the information acquired in act 7-1, that the serving access node is of type IAB Node. The wireless terminal may make the determination of act 7-2 by realizing the availability of SIBx as being periodically broadcasted by the serving access node or if SIBx can be acquired by on-demand, or if SIBx is not provided by the serving access node. Act 7-3 comprises the wireless terminal receiving from the serving access node the remaining SIB(s), including SIBx which comprises the quality of service information, that the wireless terminal desires to obtain.

Act 7-4 comprises the wireless terminal comparing the QoS Characteristics, mapped from QoS Levels provided by the IAB Node against the QoS requirements of the wireless terminal. Act 7-5 comprises the wireless terminal determining if the QoS levels broadcast by the IAB Node are sufficient to meet the QoS requirements of the wireless terminal. Act 7-6 comprises the wireless terminal determining if SIBx is cell-specific by the lack of presence of the areaScope parameter associated with SIBx. Act 7-7 comprises the wireless terminal optionally deciding to select a different serving node if the QoS level provided by the SIBx of the IAB Node do not satisfy UE the QoS requirements.

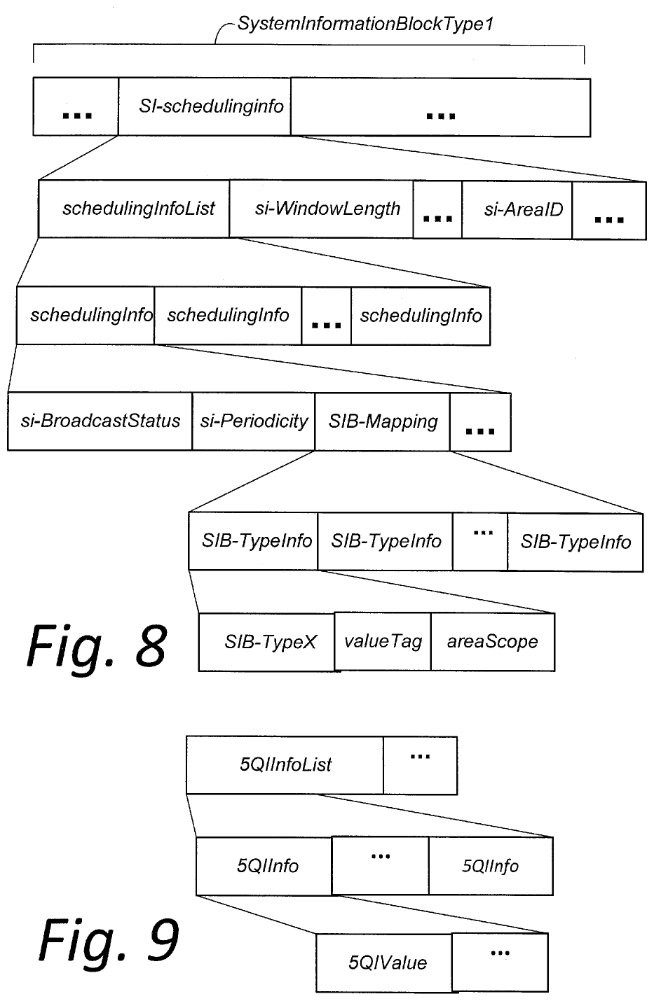

In an example implementation, the availability and delivery method information for Other SI SIBs may be included in SIB Type 1 (SIB1), which is one of the SIBs in the Minimum SI. FIG. 8 shows an example format of SIB Type 1, including schedulingInfoList, si-WindowLength, area identification (si-AreaID) and possibly other configuration parameters. FIG. 8 provides a hierarchal description of some of the elements of SIB1 to indicate the relationship between si-AreaID, sibTypeX and areaScope.

SIBs other than SIB1 are carried in SystemInformation (SI) messages and mapping of SIBs to SI messages is flexibly configurable by schedulingInfoList included in SIB1, with restrictions that: each SIB is contained only in a single SI message, only SIBs having the same scheduling requirement (periodicity given by si-periodicity) can be mapped to the same SI message. There may be multiple SI messages transmitted with the same periodicity.

Each element (schedulingInfo) of schedulingInfoList may represent one SI message, comprising its periodicity (si-Periodicity), delivery mode (si-BroadcastStatus) indicating if this SI message is currently broadcasted periodically or not (to be transmitted on-demand), and associated SIB types (si-Mapping). The actual broadcast opportunity (i.e. timing/resources) of a given SI message may be determined by a pre-determined or a network-configured formula as a function of at least the corresponding periodicity. At each opportunity the broadcast of the SI message may occur within the duration of the window length (si-WindowLength). Hereafter a broadcast opportunity is also referred as a SI window. More than one SIB may be possibly transmitted on a same SI window. Note that si-AreaID is common for all SI messages or SIB types, which means that all SIBs have the same validity area.

Each element (si-Mapping) of schedulingInfo may represent one SIB message, comprising or describing its SIB Type, its ValueTag and its areaScope. Any SIB with areaScope within the SI is considered to be area-specific and to belong to this si-AreaID, and alternately an SIB without areaScope is not area-specific and is considered as cell-specific. “Area-specific” means, e.g., uniformly offered at other available base station nodes of the radio access network.

FIG. 9 provides a hierarchal description of some of the elements of SIBx to indicate the relationship between 5QIInfoList, 5QIInfo and 5QIValue.

Table 2 provides an ASN.1 description of the system information block (SIB), e.g., SIBx that provides the set of QoS Levels (e.g. 5QIValues) which indicate the QoS Characteristics that an IAB Node such as base station node 24 can support.

TABLE 2
SIBx information element

--ASN1START
--TAG-SIBx-START

| | |
|---|---|
| SIBx ::= | SEQUENCE { |

```
  5QIInfoList 5QILIST OPTIONAL, -- Need R
  ...
}
```

| | |
|---|---|
| 5QIList ::= | SEQUENCE (SIZE (1..max5QIList)) OF 5QIInfo |
| 5QIInfo ::= | SEQUENCE { |
| 5QIValue | INTEGER (1..max5QIValue) OPTIONAL, -- Need R |

. . .
}
-- TAG-SIBx-STOP
-- ASN1STOP

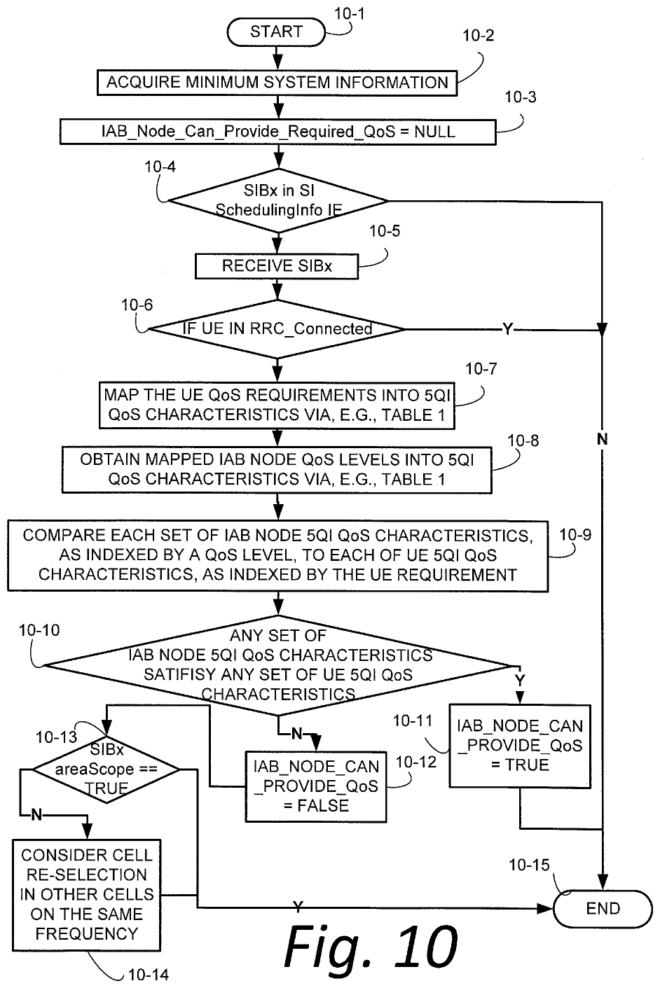

FIG. 10 shows example, basic, representative acts or steps that, in an example implementation, may be involved in executing acts of FIG. 7. Act 10-1 comprises starting the procedure of FIG. 10. Act 10-2 comprises acquiring the minimum system information, e.g., the system information necessary for basic access to the network such as the Master Information Block (MIB) and possibly the SIB1. Act 10-3 comprises initializing, at “NULL”, a parameter IAB_Node_Can_Provide_Required_QoS, whose value will be subsequently be re-set, either to “true” at act 10-11 or to “false” at act 10-13. Act 10-4 comprises determining from the minimum system information whether the minimum system information includes scheduling information, e.g., SchedulingInfo IE, for a system information block (SIB) that includes the quality of service information, e.g., SIBx. If the determination at step 10-4 is negative, the execution of the procedure of FIG. 10 terminates. On the other hand, if the determination of act 10-4 indicates that the minimum system information does include scheduling information for the SIBx, e.g., for the system information block that includes the quality of service information, as act 10-5 the user equipment (UE) 30 receives the SIBx. The SIBx is received in accordance with the scheduling information provided by the minimum system information. Following reception of the system information block SIBx that includes the quality of service information for the IAB node, as act 10-6 the wireless terminal determines whether it is in the RRC_Connected mode. If the wireless terminal is in the RRC_Connected mode, the wireless terminal is already connected to the network and thus there is no reason to check if an attachment is feasible. Therefore, if an affirmative determination is made at act 10-6 that the wireless terminal is in RRC_Connected mode, the procedure of FIG. 10 is terminated.

In view of act 10-6, the subsequent acts of the procedure of FIG. 10 are executed only if the wireless terminal is in idle or unconnected mode. Act 10-7 comprises mapping the UE quality of service requirements into 5QIValue quality of service characteristics using a predetermined mapping, such as that of Table 1. A “quality of service value” as used herein is an abbreviation or code or shortened representation of a set of quality of service parameters or characteristics, of which 5QIValue quality is a non-limiting illustrative example. For example, when anticipating use of a service and/or a connection to the network, an application 78 executed by user equipment (UE) 30 or another function executed by the user equipment (UE) 30 may provide attach controller 82 with a set of quality of service parameters or characteristics deemed necessary for the service or connection requested by the application 78 or requesting function. In act 10-7, the mapping function 88 of wireless terminal processor(s) 70 determines, e.g., which 5QIValue of Table 1 best conforms to or represents such set of quality of service parameters or characteristics as requested. Moreover, the application 78 or other requesting function may indicate several sets of quality of service parameters or characteristics, and for each such set the mapping function 88 may determine which 5QIValue of Table 1 best conforms to or represents such set of quality of service parameters or characteristics for the respective set. In such case, plural 5QIValues may be indicated as acceptable by the user equipment (UE) 30 to reflect plural sets of acceptable quality of service parameter or characteristics.

As an alternative to act 10-7, if the application 78, or other requesting function, already knows the 5QIValue(s) they correspond to the acceptable/requested set(s) of quality of service, such 5QIValue may be directly applied to the attached controller 82 without the need for mapping function 88.

Act 10-8 comprises obtaining from the SIBx, received from broadcast by the IAB-node 24, the UE quality of service information offered by the IAB-node 24. In some cases the quality of service information received in SIBx has been mapped by the IAB-node 24 into 5QIValue quality of service characteristics using a predetermined mapping, such as that of Table 1. For example, the IAB-node 24 may offer a set of service parameters or characteristics, and in generating the SIBx the IAB-node 24 has determined which 5QIValue of Table 1 best conforms to or represents such set of quality of service parameters or characteristics. Moreover, the IAB-node 24 may offer several sets of quality of service parameters or characteristics, and for each such set the IAB-node 24 has determined which 5QIValue of Table 1 best conforms to or represents such set of quality of service parameters or characteristics for the respective set. In such case, plural 5QIValues may be included in the SIBx to reflect plural sets of quality of service parameter or characteristics.

In other cases the quality of service information received in the SIBx may not be mapped to a quality of service value. IN such case of non-mapped received quality of service information, as act 10-8 the received quality of service information is assessed by mapping function 87, which generates 5QIValue(s) for the set(s) of quality of service information received in the SIBx.

Act 10-9, executed by the attach controller 82, compares each set of IAB node 5QIValue quality of service characteristics, as indexed by the appropriate number of quality of service levels, to each of the 5QIValue quality of service characteristics of/requested by the wireless terminal, as indexed by the requirements of the wireless terminal. The QoS Table (as currently defined in the TS 24.301 V15.5.0) has 21 QoS Levels. Of these 21 QoS levels, 8 levels are of type GBR, and 9 levels of type NonGBR, and 4 levels of type Delay Critical GBR.

After the comparison of act 10-9, the attach controller 82 makes a determination whether any set of IAB node 5QIValue quality of service characteristics satisfies any set of the 5QIValue quality of service characteristics of the wireless terminal. If the determination of act 10-10, the aforementioned parameter IAB_Node_Can_Provide_Required_QoS is set to TRUE as act 10-11, and the procedure of FIG. 10 terminates as shown as act 10-15. On the other hand, if the determination of act 10-10 is negative, the parameter IAB_Node_Can_Provide_Required_QoS is set to FALSE, which means that the IAB-node 24 does not provide sufficient quality of service for the requesting wireless terminal.

Having determined at act 10-12 that the IAB-node 24 does not provide sufficient quality of service for the requesting terminal, as act 10-13 the wireless terminal processor(s) 70 check to determine if the parameter areaScope, which may also be received in system information, is TRUE. If the parameter areaScope is TRUE, the wireless terminal realizes, e.g., that quality of service characterizing the just-checked IAB-node 24 is offered by other base stations, e.g., IAB nodes, of the network as well, so that it also would not be worthwhile to attempt to attach to those other base stations also. Accordingly, if at act 10-13 the parameter areaScope is TRUE, the procedure of FIG. 10 terminates at act 10-15 after execution of act 10-13. On the other hand, if the parameter areaScope is not TRUE, then the wireless terminal realizes that the wireless terminal may consider cell re-selection in other cells of the same frequency, as indicated by act 10-14. Such being the case, after terminating the procedure of FIG. 10 at act 10-15, the wireless terminal may initiate a self-reselection procedure to select another cell on the same frequency.

Table 3 is an example description, in terms of changes to 3GPP TS 38.331, of the procedures disclosed in this example embodiment and mode related to the actions taken upon reception of SIBx. Table 3 shows in particular a section 5.2.2.4.11 which may be added after 3GPP TS 38.331 section 5.2.2.4.10. 3GPP TS 38.331 is incorporated herein by reference in its entirety.

TABLE 3
Actions upon reception of SIBx

```
5.2.2.4.11  Actions upon reception of SIBx
Upon receiving the SIBx the UE shall:
  1> if in RRC_IDLE or in RRC_INACTIVE or in RRC_CONNECTED while T311 is
    running:
    (1)2>  set IAB_Node_Can_Provide_Required_QoS = NULL;
    2>if, UE has been configured with a set of QoS requirements, as mapped into TS
      23.501-f40 at table 5.7.4-1:
      3>if any of the set of UE QoS requirements match any set of QoS characteristics
        indexed by the 5QIvalues in SIBx;
        4>set IAB_Node_Can_Provide_Required_QoS = TRUE;
      3>else:
        4>set IAB_Node_Can_Provide_Required_QoS = FALSE;
        (2)4>  if areaScope is NOT present in SIBx:
          5> consider cell re-selection to other cells on the same frequency
```

### Second Embodiment

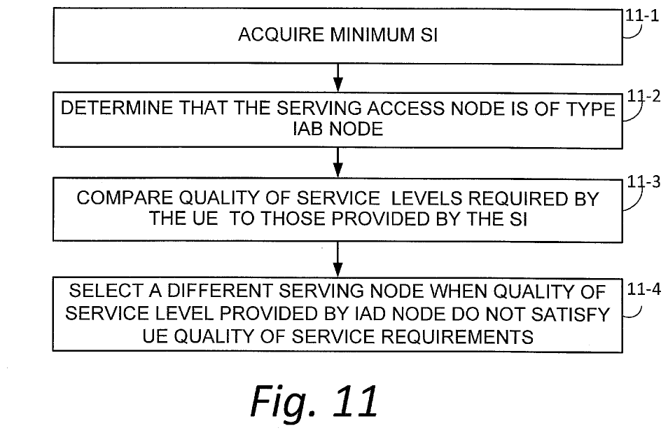

FIG. 11 describes a second example embodiment and mode. FIG. 11 particularly shows example, basic, representative high level acts or steps for a wireless terminal to determine if the IAB Node cannot provide the necessary QoS. Act 11-1 comprises the wireless terminal receiving the Minimum SI that is broadcasted from the currently serving access node. The Minimum SI may contain information about the Other SI, including the delivery method, e.g., periodic broadcast/on-demand, scheduling information, validity information, areaScope, QoS IE, etc. Act 11-2 comprises the wireless terminal optionally, based on the information acquired in act 11-1, determining that the serving access node is of type IAB Node via the availability the QoS IE. Act 11-3 comprises the wireless terminal comparing the QoS Levels of the QoS IE received from the base station node 24 against the QoS requirements of the wireless terminal. Act 11-4 comprises the wireless terminal determining if the QoS levels that the IAB Node provides are sufficient to meet the QoS requirements of the wireless terminal.

The mapping of Table 1 described in conjunction with the first example embodiment and mode may also be utilized for the second example embodiment and mode.

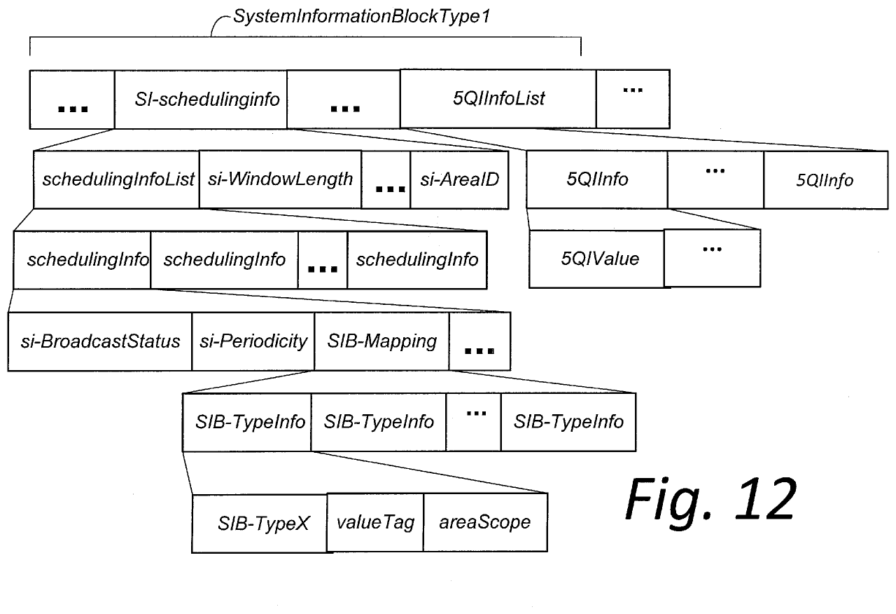

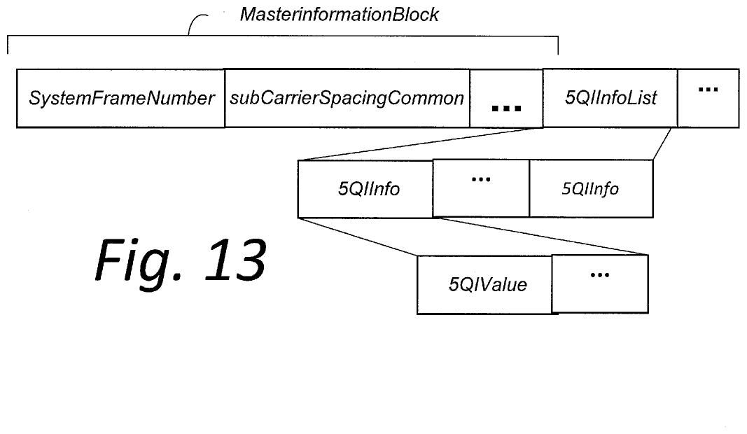

FIG. 12 provides a hierarchal description of some of the elements of SIB1 to indicate the relationship to 5QIInfoList. FIG. 13 provides a hierarchal description of some of the elements of MIB to indicate the relationship to 5QIInfoList. Table 3 again provides an ASN.1 description of the new IE that provides the set of QoS Levels, e.g. 5QIValues, which indicate the QoS Characteristics that the IAB Node can support.

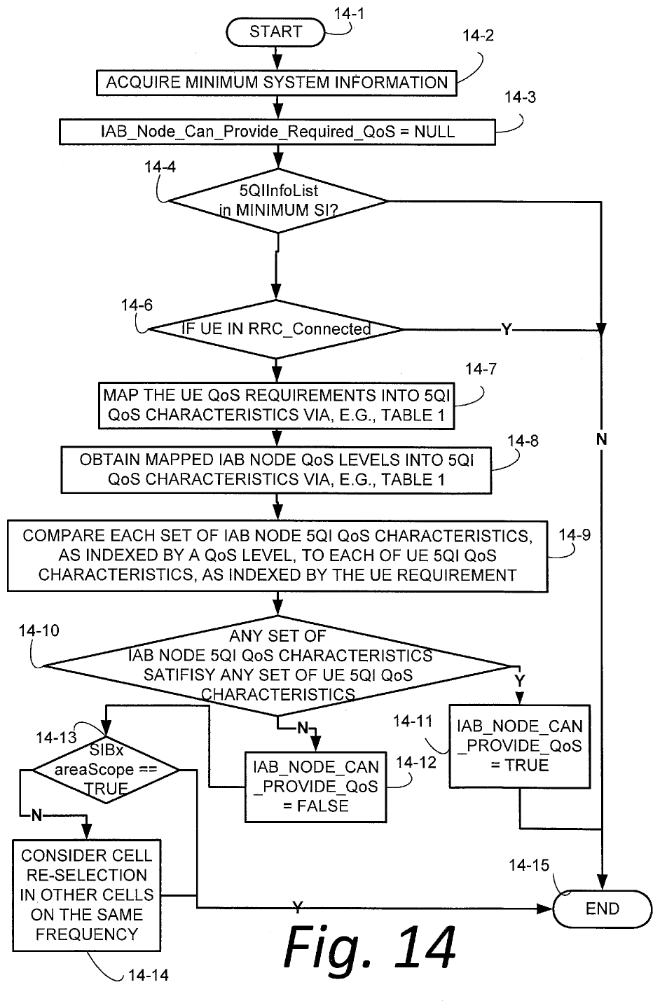

FIG. 14 shows example, basic, representative acts or steps that, in an example implementation, may be involved in executing acts of FIG. 11. Act 14-1 comprises starting the procedure of FIG. 11. Act 14-2 comprises acquiring the minimum system information, e.g., the system information necessary for basic access to the network such as the Master Information Block (MIB) and possibly the SIB 1. Act 14-3 comprises initializing, at “NULL”, a parameter IAB_Node_Can_Provide_Required_QoS, whose value will be subsequently be re-set, either to “true” at act 14-11 or to “false” at act 14-13.

In contrast to act 10-4, act 14-4 comprises determining whether the minimum system information includes a list of 5QIValues, e.g., 5QIInfoList (see, e.g., either the 5QIInfoList of SystemInformationBlockType1, as shown in FIG. 12, or the MasterInformationBlock of FIG. 13). If the determination at step 14-4 is negative, the execution of the procedure of FIG. 14 terminates. On the other hand, if the determination of act 14-4 indicates that the minimum system information does include 5QIInfoList, execution continues with act 14-6 (there being no act 14-5 in FIG. 14). As act 14-6 the wireless terminal determines whether it is in the RRC_Connected mode. If the wireless terminal is in the RRC_Connected mode, the wireless terminal is already connected to the network and thus there is no reason to check if an attachment is feasible. Therefore, if an affirmative determination is made at act 14-6 that the wireless terminal is in RRC_Connected mode, the procedure of FIG. 14 is terminated. In view of act 14-6, the subsequent acts of the procedure of FIG. 14 are executed only if the wireless terminal is in idle or unconnected mode. Subsequent acts of FIG. 14, e.g., acts 14-7 through act 14-15 inclusive, are identical to acts 10-7 through act 10-15, respectively of FIG. 10.

Table 4 is an example description, in terms of changes to 3GPP TS 38.331, of the procedures disclosed in this example embodiment and mode related to the actions taken upon reception of SIBx. Table 4 shows in particular a section 5.2.2.3.1, “Acquisition of System Information”, which may modified to accommodate and in view of the second example embodiment and mode hereof. 3GPP TS 38.331 is incorporated herein by reference in its entirety.

TABLE 4
Acquisition of System Information

```
5.2.2.3 Acquisition of System Information
5.2.2.3.1  Acquisition of MIB and SIB1
The UE shall:
  (3)1>apply the specified BCCH configuration defined in 9.1.1.1;
  (4)1>if UE is in RRC_IDLE or in RRC_INACTIVE:
    2>acquire the MIB, which is scheduled as specified in TS 38.213 [13];
    2>if the UE is unable to acquire the MIB;
      3>perform the actions as specified in clause 5.2.2.5;
    2>else:
      3>perform the actions specified in clause 5.2.2.4.1.
  (5)1>if the UE is in RRC_CONNECTED with an active BWP with common search
    space configured by searchSpaceSIB1 and pagingSearchSpace and has received an
    indication about change of system information; or
  (6)1>if UE is in RRC_IDLE or in RRC_INACTIVE:
    2>if ssb-SubcarrierOffset indicates SIB1 is transmitted in the cell (TS 38.213 [13])
      and if SIB1 acquisition is required for the UE:
      3>acquire the SIB1, which is scheduled as specified in TS 38.213 [13];
      3>if the UE is unable to acquire the SIB1:
        4>perform the actions as specified in clause 5.2.2.5;
      3>else:
        4>upon acquiring SIB1, perform the actions specified in clause 5.2.2.4.2.
    2>else if SIB1 acquisition is required for the UE and ssb-SubcarrierOffset indicates
      that SIB1 is not scheduled in the cell:
      3>perform the actions as specified in clause 5.2.2.5.
```

| | |
|---|---|
| NOTE: | The UE in RRC_CONNECTED is only required to acquire broadcasted SIB1 if |
| | the UE can acquire it without disrupting unicast data reception, i.e. the |
| | broadcast and unicast beams are quasi co-located. |

```
1> if UE is in RRC_IDLE or in RRC_INACTIVE:
  (7)2>  set IAB_Node_Can_Provide_Required_QoS = NULL;
  2>if, UE has been configured with a set of QoS requirements, as mapped into TS
    23.501-f40 at table 5.7.4-1:
    3>if any of the set of UE QoS requirements match any set of QoS characteristics
      indexed by the 5QIvalues in SIB1 or MIB;
      4>set IAB_Node_Can_Provide_Required_QoS = TRUE;
    3>else:
      4>set IAB_Node_Can_Provide_Required_QoS = FALSE;
      4> consider cell re-selection to other cells on the same frequency
```

It should be understood, with reference to all example embodiments and modes encompassed hereby, that from time to time the configuration or topology of the radio access network may change, e.g., by addition or elimination of one or more Integrated Access and Backhaul (IAB) nodes, and thus IAB links, of the radio access network. A change in the number of Integrated Access and Backhaul (IAB) nodes/links may entail also a change in the quality of service offered by a particular Integrated Access and Backhaul (IAB) node, as described above. That is, the quality of service offered by an Integrated Access and Backhaul (IAB) node may be at least partially based on network linkage remoteness of the base station apparatus relative to a donor IAB node. Accordingly, in an example embodiment and mode, an access node such as IAB-node 24 may maintain a description of the radio access network topology, e.g., as represented by network topology database 62 of FIG. 3. In some example implementations the Integrated Access and Backhaul (IAB) node itself may be capable of discovering the radio access network topology to update its network topology database 62, e.g., through links to other Integrated Access and Backhaul (IAB) nodes and accessing their network topology databases as well. In other example implementations, the network topology upon which the quality of service information may be based and stored in network topology database 62 may originate or be obtained from the network topology database 45 or network topology information maintained by donor node 22.

The technology disclosed herein thus proposes apparatus and method whereby a UE selects/rejects an attempt to attach to the NGC, via an IAB Node, based on the content of a QoS IE that is broadcasted by the IAB Node, and (optionally, in addition) area scope information broadcasted by the IAB Node in SIB1, and the QoS requirements of the wireless terminal, and using a resource efficient methods of distributing the QoS Characteristics of the IAB Node via meta data by:
An IAB Dormer to determine the set of QoS Levels, and to configure an IAB Node with a set of QoS Levels that the IAB Node is to transmit via a System Information (MIB/SIB) message broadcast. Alternately, the IAB Node self-determines the set of QoS Levels that the IAB Node is to transmit via a System Information (MIB/SIB) broadcast.
The QoS Level(s) are elements of the QoS IE, the QoS IE is an element of an IAB Node MIB/SIB message.
The QoS Level(s) are a distinct value(s), where the value(s) maps to a set of QoS Characteristics.
The set of QoS Characteristics may be defined by 3GPP, as in table 5.7.4-1 of TR 23.301, and configured into the wireless terminal and gNB at time of manufacture. Or alternately the table may be user defined and configured into the wireless device at time of provisioning.
The QoS Level(s) transmitted by the IAB Node represent the QoS Characteristics that the IAB Node can provide at the current time, as determined by the IAB Donor or IAB Node.
The wireless terminal to acquire the QoS Level(s) transmitted by the IAB Node in SI messages in order for a wireless terminal to obtain information regarding the QoS Characteristics that an IAB Node can provide.
The wireless terminal, if not connected to the NGC (i.e RRC_IDLE or RRC_INACTIVE), to make a comparison of the set of QoS Characteristics provided by the IAB Node (e.g. characteristics as indexed into to the table 5.7.4-1 of TR 23.301 via a QoS Level) and the QoS requirements of the wireless terminal.
The wireless terminal may selectively use, or not use, specific elements of the table of 23.301 when making the comparison to the QoS requirements of the wireless terminal.
The wireless terminal to determine if the IAB Node provides the necessary QoS based on the comparison of QoS Characteristics (mapped from QoS Levels) provided by the IAB Node and the QoS requirements of the wireless terminal.
The wireless terminal, may further determine if it should continue its attempt to attach to the IAB Node, and ultimately the NGC, based on the comparison of QoS Characteristics (mapped from QoS Levels) provided by the IAB Node and the wireless terminal QoS requirements and the setting of the areaScope parameter that is associated to the SIB (other than SIB1 and MIB) that transports the QoS IE.

Features from each of the example embodiments and modes described herein may be combined with one another. Further, features of the “Example Embodiments” enumerated hereinafter may also be used in conjunction with one another. Not only may features be combined, but not all features described with respect to the example embodiment and modes described above need to be performed in conjunction with other features.

As an example of features which have independent merit without necessarily being combined with other features, the system information may indicate that the node which broadcasts the system information is an Integrated Access and Backhaul (IAB) node. Accordingly, without necessarily having to perform other acts relating to quality of service, a wireless terminal may determine from the received system information that the base station apparatus is an Integrated Access and Backhaul (IAB) node and to use the system information to make a determination whether to attach to the base station apparatus.

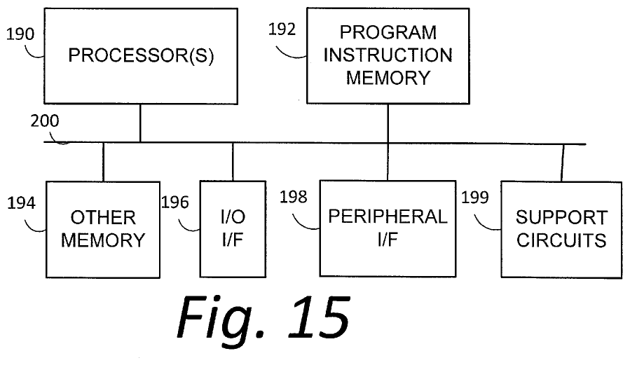

Certain units and functionalities of donor IAB node 22, base station node 24, and wireless terminal 30 are, in example embodiments, implemented by electronic machinery, computer, and/or circuitry. For example, the donor node processor(s) 44, IAB node processor(s) 54, and wireless terminal processor(s) 70 of the example embodiments herein described and/or encompassed may be comprised by the computer circuitry of FIG. 15. FIG. 15 shows an example of such electronic machinery or circuitry, whether node or terminal, as comprising one or more processor(s) circuits 190, program instruction memory 192; other memory 194 (e.g., RAM, cache, etc.); input/output interfaces 196; peripheral interfaces 198; support circuits 199; and busses 200 for communication between the aforementioned units.

The program instruction memory 192 may comprise coded instructions which, when executed by the processor(s), perform acts including but not limited to those described herein. Thus is understood that each of donor node processor(s) 44, IAB node processor(s) 54, and wireless terminal processor(s) 70, for example, comprise memory in which non-transient instructions are stored for execution.

The memory 194, or computer-readable medium, may be one or more of readily available memory such as random access memory (RAM), read only memory (ROM), floppy disk, hard disk, flash memory or any other form of digital storage, local or remote, and is preferably of non-volatile nature. The support circuits 199 are coupled to the processors 190 for supporting the processor in a conventional manner. These circuits include cache, power supplies, clock circuits, input/output circuitry and subsystems, and the like.

Further, it should be understood that, when a processor or processor circuitry is mentioned in conjunction with any of the preceding example embodiments and modes, it should be understood that the device hosting the processor, whether wireless terminal or access node, may comprise at least one processor and at least one memory including computer program code, the memory and the computer program code being configured to, working with the at least one processor, to cause the host device to perform the functions afore-described.

Thus, the technology disclosed herein solves problems in the field of telecommunications, including problems in telecommunications nodes such wireless terminals and access nodes, as well as computers/processors and hardware comprising such nodes. System information is of utmost importance to the operation of telecommunication nodes, so that each node can obtain the necessary network information to coordinate and communicate with other nodes and to perform its desired functions. The system information is quite extensive and complex, and may be changeable/updateable due to changing network configuration, network load, and operating conditions, for example. The technology disclosed herein affords a wireless terminal, e.g., an opportunity to assess likelihood of success of an attempted attachment to a core network through a certain Integrated Access and Backhaul (IAB) node, and to make an early determination regarding likelihood of success earlier and more efficiently, thereby avoiding waste of time and processing resources. In particular, the technology disclosed herein solves a problem that occurs when a user equipment or wireless terminal seeks to blindly make an attachment to a network through an Integrated Access and Backhaul (IAB) node without knowing, e.g., the quality of service offered by the Integrated Access and Backhaul (IAB) node.

The following is a list of documents that may be pertinent to one or more aspects of the technology disclosed herein (all of which are incorporated herein by reference in their entirety):

3GPP TS 38.331 V15.4.0 (2018-12) Technical Specification 3rd Generation Partnership Project; Technical Specification Group Radio Access Network; NR; Radio Resource Control (RRC) protocol specification (Release 15)

3GPP TR 38.874 V16.0.0 (2018-12) Technical Report 3rd Generation Partnership Project; Technical Specification Group Radio Access Network; NR; Study on Integrated Access and Backhaul; (Release 16)

3GPP TS 23.501 V15.4.0 (2018-12) Technical Specification 3rd Generation Partnership Project; Technical Specification Group Services and System Aspects; System Architecture for the 5G System; Stage 2 (Release 15)

3GPP TS 23.502 V15.4.1 (2019-01) Technical Specification 3rd Generation Partnership Project; Technical Specification Group Services and System Aspects; Procedures for the 5G System; Stage 2 (Release 15)

The technology of this application thus encompasses but is not limited to the following example embodiments, example features, and example advantages:

### Example Embodiments 1.1-1.20

1.1 A user equipment that communicates over a radio interface with a base station apparatus of a radio access network (RAN), the user equipment comprising:
receiver circuitry configured to receive first type system information (SI) from the base station apparatus, the first type SI comprising:
   availability of second type SI message(s), a second type SI message comprising at least one system information block (SIB);
   scheduling information of each of the second type SI message(s);
   area coverage indicator for each of the second type SI messages, the area coverage being either cell specific or area specific;
processor circuitry configured to:
   use the receiver circuitry to initiate the SI message acquisition process;
1.2 The user equipment of Example Embodiment 1.1, wherein the second type SI message is received
1.3 The user equipment of Example Embodiment 1.2, wherein the received second type SI message comprises at least a list of QoS Levels
1.4 A method for a user equipment that communicates over a radio interface with a base station apparatus of a radio access network (RAN), comprising:
receiving first type system information (SI) from the base station apparatus, the first type SI comprising:
   availability of second type SI message(s), a second type SI message comprising at least one system information block (SIB);
   scheduling information of each of the second type SI message(s);
   area coverage indicator for each of the second type SI messages, the area coverage indicator being either cell specific or area specific;
initiating the SI message acquisition process;
1.5 The method of Example Embodiment 1.4, wherein the second type SI message is received.
1.6 The method of Example Embodiment 1.5, wherein the received second type SI message comprises at least a list of QoS Levels.
1.7 The method of Example Embodiment 1.6, wherein list of QoS Levels is compared to a list of user equipment QoS requirements.
1.8 The method of Example Embodiment 1.7 wherein the at least one QoS Level satisfies at least one user equipment QoS requirement.
1.9 The method of Example Embodiment 1.8 wherein a variable is set to indicate that the IABNode can support a QoS requirement of the user equipment.
1.10 The method of Example Embodiment 1.7 wherein the no QoS Level satisfies any user equipment QoS requirement.
1.11 The method of Example Embodiment 1.10 wherein a variable is set to indicate that the IABNode cannot support a QoS requirement of the user equipment.
1.12 The method of Example Embodiment 1.11 wherein the second type SI message is cell specific.
1.13 The method of Example Embodiment 1.12 wherein an indication is made to the cell re-selection algorithm to consider other cells of the same frequency.
1.14 A base station apparatus of a radio access network (RAN) that communicates over a radio interface with a user equipment, the base station apparatus comprising:
transmitter circuitry configured to transmit first type system information (SI), the first type SI comprising:
   availability of second type SI message(s), a second type SI message comprising at least one system information block (SIB);
   scheduling information of each of the SI message(s);
   area coverage indicator for each of the second type SI message(s), the area coverage indicator being either cell specific or area specific;
processor circuitry configured to:
   use the transmitter circuitry to deliver SI messages.
1.15 The base station apparatus of Example Embodiment 1.14, wherein a second type SI message is transmitted
1.16 The base station apparatus of Example Embodiment 1.15, wherein a transmitted second type SI message comprises at least a list of QoS Levels
1.17 A method for a base station apparatus of a radio access network (RAN) that communicates over a radio interface with a user equipment, comprising:
transmitting first type system information (SI), the first type SI comprising:
   availability of second type SI message(s), a second type SI message comprising at least one system information block (SIB);
   scheduling information of each of the SI message(s);
   area coverage indicator for each of the second type SI messages, the area coverage indicator being either cell specific or area specific;
1.18 The method of Example Embodiment 1.17, wherein a second type SI message is transmitted
1.19 The method of Example Embodiment 1.18, wherein a transmitted second type SI message comprises at least a list of QoS Levels
1.20 The method of Example Embodiment 1.19, wherein the list of QoS Levels is configured by either the IABNode or the IABDoner;

### Example Embodiments 2.1-2.11

2.1 A user equipment that communicates over a radio interface with a base station apparatus of a radio access network (RAN), the user equipment comprising:
receiver circuitry configured to receive first type system information (SI) from the base station apparatus, the first type SI comprising:
   availability of second type SI message(s), a second type SI message comprising at least one system information block (SIB);
   scheduling information of each of the second type SI message(s);
   a list of QoS Levels;
processor circuitry configured to:
   use the receiver circuitry to initiate the SI message acquisition process;
2.2 A method for a user equipment that communicates over a radio interface with a base station apparatus of a radio access network (RAN), comprising:
receiving first type system information (SI) from the base station apparatus, the first type SI comprising:
   availability of second type SI message(s), a second type SI message comprising at least one system information block (SIB);
   scheduling information of each of the second type SI message(s);
   a list of QoS Levels;
2.3 The method of Example Embodiment 2.1, wherein list of QoS Levels is compared to a list of user equipment QoS requirements.
2.4 The method of Example Embodiment 2.3 wherein the at least one QoS Levels satisfies at least one user equipment QoS requirement.
2.5 The method of Example Embodiment 2.4 wherein a variable is set to indicate that the IABNode can support a QoS requirement of the user equipment.
2.6 The method of Example Embodiment 2.3 wherein the no QoS Levels satisfies any user equipment QoS requirement.
2.7 The method of Example Embodiment 2.6 wherein a variable is set to indicate that the IABNode cannot support a QoS requirement of the user equipment.
2.8 The method of Example Embodiment 2.7 wherein an indication is made to the cell re-selection algorithm to consider other cells of the same frequency.
2.9 A base station apparatus of a radio access network (RAN) that communicates over a radio interface with a user equipment, the base station apparatus comprising:
transmitter circuitry configured to transmit first type system information (SI), the first type SI comprising:
   availability of second type SI message(s), the second type SI message comprising at least one system information block (SIB);
   scheduling information for each of the second type of SI message(s);
   a list of QoS Levels;
processor circuitry configured to:
   use the transmitter circuitry to deliver SI messages.
2.10 A method for a base station apparatus of a radio access network (RAN) that communicates over a radio interface with a user equipment, comprising:
transmitting first type system information (SI), the first type SI comprising:
   availability of a second type SI message(s), the second type SI message comprising at least one system information block (SIB);
   scheduling information for each of the second type of SI message(s);
   a list of QoS Levels;
2.11 The method of Example Embodiment 2.10, wherein the list of QoS Levels is configured by either the IABNode or the IABDoner.

### Generic Example Embodiments 3.1-3.64

3.1 A base station apparatus of a radio access network comprising:
processor circuitry configured to provide system information including quality of service information describing a quality of service offered by the base station apparatus;
transmitter circuitry configured to transmit the system information over a radio interface to a wireless terminal to enable the wireless terminal to use the quality of service information to determine whether to attach to the base station apparatus.
3.2 The base station apparatus of claim 3.1, wherein the quality of service information is at least partially based on network linkage remoteness of the base station apparatus relative to a donor IAB node.
3.3 The base station apparatus of claim 3.1, wherein the processor circuitry is configured to provide the system information to include an indication that the base station apparatus is an Integrated Access and Backhaul (IAB) node.
3.4 The base station apparatus of claim 3.1, wherein the processor circuitry is configured to provide first type system information and second type system information, the first type system information including availability of a second type system information message and scheduling information for the second type system information message, the quality of service information being included in a system information block (SIB) of the second type system information message.
3.5 ‘The base station apparatus of claim 3.1, wherein the processor circuitry is configured to provide the system information whereby the quality of service information is included in a system information block (SIB) which exclusively includes system information for an Integrated Access and Backhaul (IAB) node.
3.6 The base station apparatus of claim 3.1, wherein the processor circuitry is configured to ascertain the network linkage remoteness of the base station apparatus relative to the donor IAB node
3.7 The base station apparatus of claim 3.6, wherein the processor circuitry is configured to ascertain network linkage remoteness of the base station apparatus relative to the donor IAB node based on configured network topological information stored at the base station apparatus
3.8 The base station apparatus of claim 3.6, wherein the network linkage remoteness of the base station apparatus relative to the donor IAB node is dynamic, and wherein the processor circuitry is configured to update the network linkage remoteness of the base station apparatus relative to the donor IAB node based on network topological information received from the network.
3.9 The base station apparatus of claim 3.1, wherein the processor circuitry is configured to provide the system information to include a quality of service value.
3.10 The base station apparatus of claim 3.9, wherein the quality of service value is associated with plural quality of service parameters.
3.11 The base station apparatus of claim 3.9, wherein the quality of service value is a standardized 5QIValue.
3.12 The base station apparatus of claim 3.9, wherein the processor circuitry is configured to provide the system information to include plural quality of service values.
3.13 The base station apparatus of claim 3.9, wherein the processor circuitry is configured to provide the system information to include an area scope parameter associated with the quality of service value, the area scope parameter indicating whether the quality of service indicated by the quality of service value is cell specific or area specific (e.g., uniformly offered at other available base station nodes of the radio access network)
3.14 A method in a base station apparatus of a radio access network comprising:
providing system information including quality of service information describing a quality of service offered by the base station apparatus;
transmitting the system information over a radio interface to a wireless terminal to enable the wireless terminal to use the quality of service information to determine whether to attach to the base station apparatus
3.15 The method of claim 3.14, wherein the quality of service information is at least partially based on network linkage remoteness of the base station apparatus relative to a donor IAB node.
3.16 The method of claim 3.14, further comprising providing the system information to include an indication that the base station apparatus is an Integrated Access and Backhaul (IAB) node.
3.17 The method of claim 3.14, further comprising providing first type system information and second type system information, the first type system information including availability of a second type system information message and scheduling information for the second type system information message, the quality of service information being included in a system information block (SIB) of the second type system information message.
3.18 The method of claim 3.14, further comprising providing the system information whereby the quality of service information is included in a system information block (SIB) which exclusively includes system information for an Integrated Access and Backhaul (IAB) node.
3.19 The method of claim 3.14, further comprising ascertaining the network linkage remoteness of the base station apparatus relative to the donor IAB node.
3.20 The method of claim 3.19, further comprising ascertaining network linkage remoteness of the base station apparatus relative to the donor IAB node based on configured network topological information stored at the base station apparatus.
3.21 The method of claim 3.19, wherein the network linkage remoteness of the base station apparatus relative to the donor IAB node is dynamic, and wherein the method further comprises updating the network linkage remoteness of the base station apparatus relative to the donor IAB node based on network topological information received from the network.
3.22 The method of claim 3.14 wherein the processor circuitry is configured to provide the system information to include a quality of service value.
3.23 The method of claim 3.22, wherein the quality of service value is associated with plural quality of service parameters.
3.24 The method of claim 3.22, wherein the quality of service value is a standardized 5QIValue.
3.25 The method of claim 3.22, further comprising providing the system information to include plural quality of service values.
3.26 The method of claim 3.22, further comprising providing the system information to include an area scope parameter associated with the quality of service value, the area scope parameter indicating whether the quality of service indicated by the quality of service value is cell specific or area specific (e.g., uniformly offered at other available base station nodes of the radio access network).
3.27 A wireless terminal which communicates with a base station apparatus of a radio access network across a radio interface, the wireless teuitinal comprising:
receiver circuitry configured to obtain quality of service information broadcast by the base station apparatus;
processor circuitry configured:
   to obtain a quality of service parameter requested for a connection to the radio access network;
   to use the quality of service information broadcast by the base station apparatus and the quality of the service parameter requested for the connection to determine whether to attach to the base station apparatus.
3.28 The wireless terminal of claim 3.27, wherein the quality of service information broadcast by the base station apparatus being dependent on network linkage remoteness of the base station apparatus relative to a donor IAB node.
3.29 The wireless terminal of claim 3.27, wherein the processor circuitry is further configured, in a case that the quality of service information broadcast by the base station apparatus does not warrant attachment by the wireless terminal to the base station apparatus, to select a cell served by another base station apparatus for the attachment.
3.30 The wireless terminal of claim 3.27, wherein the processor circuitry is further configured, in a case that the quality of service information broadcast by the base station apparatus does warrant attachment by the wireless terminal to the base station apparatus, to perform an attachment operation to the base station apparatus.
3.31 The wireless terminal of claim 3.27, wherein the processor circuitry is further configured to obtain the quality of service parameter requested for the connection from an application which is executed at the wireless terminal.
3.32 The wireless terminal of claim 3.27, wherein the processor circuitry is further configured:

to obtain the quality of service parameter requested for the connection as a requested quality of service value and to receive a broadcasted quality of service value from the broadcasted quality of service information, and
to use the requested quality of service value and the broadcasted quality of service value to determine whether to attach to the base station apparatus.
3.33 The wireless terminal of claim 3.32, wherein the processor circuitry is further configured:
to receive plural broadcasted quality of service values from the broadcasted quality of service information, and
to determine whether the quality of service information broadcasted by the base station apparatus warrants the attachment by the wireless terminal to the base station apparatus by making a favorable comparison of the requested quality of service value with any one of the plural broadcasted quality of service values.
3.34 The wireless terminal of claim 3.33, wherein processor circuitry is configured:
to obtain plural requested quality of service values, and
to determine whether the quality of service information broadcasted by the base station apparatus warrants the attachment by the wireless terminal to the base station apparatus by making a favorable comparison of any one of the requested quality of service values with any one of the plural broadcasted quality of service values.
3.35 The wireless terminal of claim 3.32, wherein the requested quality of service value and the broadcasted quality of service value are standardized 5QIValues.
3.36 The wireless terminal of claim 3.27, wherein the processor circuitry is further configured:
to translate the quality of service parameter requested for the connection into a requested quality of service value and to receive a broadcasted quality of service value from the broadcasted quality of service information, and
to use the quality of service information broadcast by the base station apparatus and the quality of the requested service parameter value to determine whether to attach to the base station apparatus.
3.37 The wireless terminal of claim 3.36, wherein the processor circuitry is further configured:
to receive plural broadcasted quality of service values from the broadcasted quality of service information, and
to determine whether the quality of service information broadcasted by the base station apparatus warrants the attachment by the wireless terminal to the base station apparatus by making a favorable comparison of the requested quality of service value with any one of the plural broadcasted quality of service values.
3.38 The wireless terminal of claim 3.37, wherein processor circuitry is configured:
to translate one or more quality of service parameters requested for the connection into plural requested quality of service values, and
to determine whether the quality of service information broadcasted by the base station apparatus warrants the attachment by the wireless terminal to the base station apparatus by making a favorable comparison of any one of the requested quality of service values with any one of the plural broadcasted quality of service values.
3.39 The wireless terminal of claim 3.36, wherein the requested quality of service value and the broadcasted quality of service value are standardized 5QIValues.
3.40 The wireless terminal of claim 3.27, wherein the quality of service information broadcast by the base station apparatus comprises an associated area scope parameter, the area scope parameter indicating whether the quality of service indicated by the quality of service information is cell specific or area specific (e.g., uniformly offered at other available base station nodes of the radio access network), and wherein the processor circuitry is further configured, in a case that the quality of service information broadcast by the base station apparatus does not warrant attachment by the wireless terminal to the base station apparatus and the area scope parameter specifies that the quality of service information is cell specific, to select a cell served by another base station apparatus for the attachment.
3.41 The wireless terminal of claim 3.40, wherein the quality of service information broadcast by the base station apparatus comprises an quality of service value, and wherein the quality of service value has the associated area scope parameter.
3.42 The wireless terminal of claim 3.40, wherein the quality of service information broadcast by the base station apparatus comprises plural quality of service values, and wherein each of the plural quality of service values is associated with an area scope parameter.
3.43 A method in a wireless terminal which communicates with a base station apparatus of a radio access network across a radio interface, the method comprising:
obtaining quality of service information broadcast by the base station apparatus;
obtaining a quality of service parameter requested for a connection to the radio access network;
using the quality of service information broadcast by the base station apparatus and the quality of the service parameter requested for the connection to determine whether to attach to the base station apparatus.
3.44 The method of claim 3.43, wherein the quality of service information broadcast by the base station apparatus being dependent on network linkage remoteness of the base station apparatus relative to a donor IAB node.
3.45 The method of claim 3.43, wherein the processor circuitry is further configured, in a case that the quality of service information broadcast by the base station apparatus does not warrant attachment by the wireless terminal to the base station apparatus, to select a cell served by another base station apparatus for the attachment.
3.46 The method of claim 3.43, wherein the processor circuitry is further configured, in a case that the quality of service information broadcast by the base station apparatus does warrant attachment by the wireless terminal to the base station apparatus, to perform an attachment operation to the base station apparatus.
3.47 The method of claim 3.43, wherein the processor circuitry is further configured to obtain the quality of service parameter requested for the connection from an application which is executed at the wireless terminal.
3.48 The method of claim 3.43, wherein the processor circuitry is further configured:
to obtain the quality of service parameter requested for the connection as a requested quality of service value and to receive a broadcasted quality of service value from the broadcasted quality of service information, and
to use the requested quality of service value and the broadcasted quality of service value to determine whether to attach to the base station apparatus.
3.49 The method of claim 3.43, wherein the processor circuitry is further configured:
to receive plural broadcasted quality of service values from the broadcasted quality of service information, and
to determine whether the quality of service information broadcasted by the base station apparatus warrants the attachment by the wireless terminal to the base station apparatus by making a favorable comparison of the requested quality of service value with any one of the plural broadcasted quality of service values.
3.50 The method of claim 3.49, wherein processor circuitry is configured:
to obtain plural requested quality of service values, and
to determine whether the quality of service information broadcasted by the base station apparatus warrants the attachment by the wireless terminal to the base station apparatus by making a favorable comparison of any one of the requested quality of service values with any one of the plural broadcasted quality of service values.
3.51 The method of claim 3.48, wherein the requested quality of service value and the broadcasted quality of service value are standardized 5QIValues.
3.52 The method of claim 3.43, wherein the processor circuitry is further configured:
to translate the quality of service parameter requested for the connection into a requested quality of service value and to receive a broadcasted quality of service value from the broadcasted quality of service information, and
to use the quality of service information broadcast by the base station apparatus and the quality of the requested service parameter value to determine whether to attach to the base station apparatus.
3.53 The method of claim 3.52, wherein the processor circuitry is further configured:
to receive plural broadcasted quality of service values from the broadcasted quality of service information, and
to determine whether the quality of service information broadcasted by the base station apparatus warrants the attachment by the wireless terminal to the base station apparatus by making a favorable comparison of the requested quality of service value with any one of the plural broadcasted quality of service values.
3.54 The method of claim 3.53, wherein processor circuitry is configured:
to translate one or more quality of service parameters requested for the connection into plural requested quality of service values, and
to determine whether the quality of service information broadcasted by the base station apparatus warrants the attachment by the wireless terminal to the base station apparatus by making a favorable comparison of any one of the requested quality of service values with any one of the plural broadcasted quality of service values.
3.55 The method of claim 3.52, wherein the requested quality of service value and the broadcasted quality of service value are standardized 5QIValues.
3.56 The method of claim 55, wherein the quality of service information broadcast by the base station apparatus comprises an associated area scope parameter, the area scope parameter indicating whether the quality of service indicated by the quality of service information is cell specific or area specific (e.g., uniformly offered at other available base station nodes of the radio access network), and wherein the processor circuitry is further configured, in a case that the quality of service information broadcast by the base station apparatus does not warrant attachment by the wireless terminal to the base station apparatus and the area scope parameter specifies that the quality of service information is cell specific, to select a cell served by another base station apparatus for the attachment.
3.57 The method of claim 56, wherein the quality of service information broadcast by the base station apparatus comprises an quality of service value, and wherein the quality of service value has the associated area scope parameter.
3.58 The method of claim 3.56, wherein the quality of service information broadcast by the base station apparatus comprises plural quality of service values, and wherein each of the plural quality of service values is associated with an area scope parameter
3.59 A wireless terminal which communicates with a base station apparatus of a radio access network over a radio interface, the wireless terminal comprising:
receiver circuitry configured to receive system information broadcast by the base station apparatus;
processor circuitry configured to determine from the received system information that the base station apparatus is an Integrated Access and Backhaul (IAB) node and to use the system information to make a determination whether to attach to the base station apparatus.
3.60 The wireless terminal of claim 3.59, wherein the received system information comprises quality of service information indicating a quality of service provided by the base station apparatus.
3.61 The wireless terminal of claim 3.59, wherein the received system information comprises an indication of whether the received system information is cell specific or network specific.
3.62 A method in a wireless terminal which communicates with a base station apparatus of a radio access network over a radio interface, the wireless terminal comprising:
receiving system information broadcast by the base station apparatus;
determining from the received system information that the base station apparatus is an Integrated Access and Backhaul (IAB) node and to use the system information to make a determination whether to attach to the base station apparatus.
3.63 The method of claim 62, wherein the received system information comprises quality of service information indicating a quality of service provided by the base station apparatus.
3.64 The method of claim 3.62, wherein the received system information comprises an indication of whether the received system information is cell specific or network specific.

Although the processes and methods of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routines of the disclosed embodiments are capable of being executed on any computer operating system, and is capable of being performed using any CPU architecture. The instructions of such software are stored on non-transient computer readable media.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented.

Nodes that communicate using the air interface also have suitable radio communications circuitry. Moreover, the technology can additionally be considered to be embodied entirely within any form of computer-readable memory, such as solid-state memory, magnetic disk, or optical disk containing an appropriate set of computer instructions that would cause a processor to carry out the techniques described herein.

It will be appreciated that the technology disclosed herein is directed to solving radio communications-centric issues and is necessarily rooted in computer technology and overcomes problems specifically arising in radio communications. Moreover, in at least one of its aspects the technology disclosed herein improves the functioning of the basic function of a wireless terminal and/or node itself so that, for example, the wireless terminal and/or node can operate more effectively by prudent use of radio resources.

Although the description above contains many specificities, these should not be construed as limiting the scope of the technology disclosed herein but as merely providing illustrations of some of the presently preferred embodiments of the technology disclosed herein. Thus the scope of the technology disclosed herein should be determined by the appended claims and their legal equivalents. Therefore, it will be appreciated that the scope of the technology disclosed herein fully encompasses other embodiments which may become obvious to those skilled in the art, and that the scope of the technology disclosed herein is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology disclosed herein, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

### SUMMARY

In one example, a base station apparatus of a radio access network comprising: processor circuitry configured to provide system information including quality of service information describing a quality of service offered by the base station apparatus; transmitter circuitry configured to transmit the system information over a radio interface to a wireless terminal to enable the wireless terminal to use the quality of service information to determine whether to attach to the base station apparatus.

In one example, the base station apparatus, wherein the quality of service information is at least partially based on network linkage remoteness of the base station apparatus relative to a donor IAB node.

In one example, the base station apparatus, wherein the processor circuitry is configured to provide the system information to include an indication that the base station apparatus is an Integrated Access and Backhaul (IAB) node.

In one example, the base station apparatus, wherein the processor circuitry is configured to provide first type system information and second type system information, the first type system information including availability of a second type system information message and scheduling information for the second type system information message, the quality of service information being included in a system information block (SIB) of the second type system information message.

In one example, the base station apparatus, wherein the processor circuitry is configured to provide the system information whereby the quality of service information is included in a system information block (SIB) which exclusively includes system information for an Integrated Access and Backhaul (IAB) node.

In one example, the base station apparatus, wherein the processor circuitry is configured to ascertain the network linkage remoteness of the base station apparatus relative to the donor IAB node.

In one example, the base station apparatus, wherein the processor circuitry is configured to ascertain network linkage remoteness of the base station apparatus relative to the donor IAB node based on configured network topological information stored at the base station apparatus.

In one example, the base station apparatus, wherein the network linkage remoteness of the base station apparatus relative to the donor IAB node is dynamic, and wherein the processor circuitry is configured to update the network linkage remoteness of the base station apparatus relative to the donor IAB node based on network topological information received from the network.

In one example, the base station apparatus, wherein the processor circuitry is configured to provide the system information to include a quality of service value.

In one example, the base station apparatus, wherein the quality of service value is associated with plural quality of service parameters.

In one example, the base station apparatus, wherein the quality of service value is a standardized 5QIValue.

In one example, the base station apparatus, wherein the processor circuitry is configured to provide the system information to include plural quality of service values.

In one example, the base station apparatus, wherein the processor circuitry is configured to provide the system information to include an area scope parameter associated with the quality of service value, the area scope parameter indicating whether the quality of service indicated by the quality of service value is cell specific or area specific (e.g., uniformly offered at other available base station nodes of the radio access network).

In one example, a method in a base station apparatus of a radio access network comprising: providing system information including quality of service information describing a quality of service offered by the base station apparatus; transmitting the system information over a radio interface to a wireless terminal to enable the wireless terminal to use the quality of service information to determine whether to attach to the base station apparatus.

In one example, the method, wherein the quality of service information is at least partially based on network linkage remoteness of the base station apparatus relative to a donor IAB node.

In one example, the method, further comprising providing the system information to include an indication that the base station apparatus is an Integrated Access and Backhaul (IAB) node.

In one example, the method, further comprising providing first type system information and second type system information, the first type system information including availability of a second type system information message and scheduling information for the second type system information message, the quality of service information being included in a system information block (SIB) of the second type system information message.

In one example, the method, further comprising providing the system information whereby the quality of service information is included in a system information block (SIB) which exclusively includes system information for an Integrated Access and Backhaul (IAB) node.

In one example, the method, further comprising ascertaining the network linkage remoteness of the base station apparatus relative to the donor IAB node.

In one example, the method, further comprising ascertaining network linkage remoteness of the base station apparatus relative to the donor IAB node based on configured network topological information stored at the base station apparatus.

In one example, the method, wherein the network linkage remoteness of the base station apparatus relative to the donor IAB node is dynamic, and wherein the method further comprises updating the network linkage remoteness of the base station apparatus relative to the donor IAB node based on network topological information received from the network.

In one example, the method, wherein the processor circuitry is configured to provide the system information to include a quality of service value.

In one example, the method, wherein the quality of service value is associated with plural quality of service parameters.

In one example, the method, wherein the quality of service value is a standardized 5QIValue.

In one example, the method, further comprising providing the system information to include plural quality of service values.

In one example, the method, further comprising providing the system information to include an area scope parameter associated with the quality of service value, the area scope parameter indicating whether the quality of service indicated by the quality of service value is cell specific or area specific.

In one example, a wireless terminal which communicates with a base station apparatus of a radio access network across a radio interface, the wireless terminal comprising: receiver circuitry configured to obtain quality of service information broadcast by the base station apparatus; processor circuitry configured: to obtain a quality of service parameter requested for a connection to the radio access network; to use the quality of service information broadcast by the base station apparatus and the quality of the service parameter requested for the connection to determine whether to attach to the base station apparatus.

In one example, the wireless terminal, wherein the quality of service information broadcast by the base station apparatus being dependent on network linkage remoteness of the base station apparatus relative to a donor IAB node.

In one example, the wireless terminal, wherein the processor circuitry is further configured, in a case that the quality of service information broadcast by the base station apparatus does not warrant attachment by the wireless terminal to the base station apparatus, to select a cell served by another base station apparatus for the attachment.

In one example, the wireless terminal, wherein the processor circuitry is further configured, in a case that the quality of service information broadcast by the base station apparatus does warrant attachment by the wireless terminal to the base station apparatus, to perform an attachment operation to the base station apparatus.

In one example, the wireless terminal, wherein the processor circuitry is further configured to obtain the quality of service parameter requested for the connection from an application which is executed at the wireless terminal.

In one example, the wireless terminal, wherein the processor circuitry is further configured: to obtain the quality of service parameter requested for the connection as a requested quality of service value and to receive a broadcasted quality of service value from the broadcasted quality of service information, and to use the requested quality of service value and the broadcasted quality of service value to determine whether to attach to the base station apparatus.

In one example, the wireless terminal, wherein the processor circuitry is further configured: to receive plural broadcasted quality of service values from the broadcasted quality of service information, and to determine whether the quality of service information broadcasted by the base station apparatus warrants the attachment by the wireless terminal to the base station apparatus by making a favorable comparison of the requested quality of service value with any one of the plural broadcasted quality of service values.

In one example, the wireless terminal, wherein processor circuitry is configured: to obtain plural requested quality of service values, and to determine whether the quality of service information broadcasted by the base station apparatus warrants the attachment by the wireless terminal to the base station apparatus by making a favorable comparison of any one of the requested quality of service values with any one of the plural broadcasted quality of service values.

In one example, the wireless terminal, wherein the requested quality of service value and the broadcasted quality of service value are standardized 5QIValues.

In one example, the wireless terminal, wherein the processor circuitry is further configured: to translate the quality of service parameter requested for the connection into a requested quality of service value and to receive a broadcasted quality of service value from the broadcasted quality of service information, and to use the quality of service information broadcast by the base station apparatus and the quality of the requested service parameter value to determine whether to attach to the base station apparatus.

In one example, the wireless terminal, wherein the processor circuitry is further configured: to receive plural broadcasted quality of service values from the broadcasted quality of service information, and to determine whether the quality of service information broadcasted by the base station apparatus warrants the attachment by the wireless terminal to the base station apparatus by making a favorable comparison of the requested quality of service value with any one of the plural broadcasted quality of service values.

In one example, the wireless terminal, wherein processor circuitry is configured: to translate one or more quality of service parameters requested for the connection into plural requested quality of service values, and to determine whether the quality of service information broadcasted by the base station apparatus warrants the attachment by the wireless terminal to the base station apparatus by making a favorable comparison of any one of the requested quality of service values with any one of the plural broadcasted quality of service values.

In one example, the wireless terminal, wherein the requested quality of service value and the broadcasted quality of service value are standardized 5QIValues.

In one example, the wireless terminal, wherein the quality of service information broadcast by the base station apparatus comprises an associated area scope parameter, the area scope parameter indicating whether the quality of service indicated by the quality of service information is cell specific or area specific (e.g., uniformly offered at other available base station nodes of the radio access network), and wherein the processor circuitry is further configured, in a case that the quality of service information broadcast by the base station apparatus does not warrant attachment by the wireless terminal to the base station apparatus and the area scope parameter specifies that the quality of service information is cell specific, to select a cell served by another base station apparatus for the attachment.

In one example, the wireless terminal, wherein the quality of service information broadcast by the base station apparatus comprises an quality of service value, and wherein the quality of service value has the associated area scope parameter.

In one example, the wireless terminal, wherein the quality of service information broadcast by the base station apparatus comprises plural quality of service values, and wherein each of the plural quality of service values is associated with an area scope parameter.

In one example, a method in a wireless terminal which communicates with a base station apparatus of a radio access network across a radio interface, the method comprising: obtaining quality of service information broadcast by the base station apparatus; obtaining a quality of service parameter requested for a connection to the radio access network; using the quality of service information broadcast by the base station apparatus and the quality of the service parameter requested for the connection to determine whether to attach to the base station apparatus.

In one example, the method, wherein the quality of service information broadcast by the base station apparatus being dependent on network linkage remoteness of the base station apparatus relative to a donor IAB node.

In one example, the method, wherein the processor circuitry is further configured, in a case that the quality of service information broadcast by the base station apparatus does not warrant attachment by the wireless terminal to the base station apparatus, to select a cell served by another base station apparatus for the attachment.

In one example, the method, wherein the processor circuitry is further configured, in a case that the quality of service information broadcast by the base station apparatus does warrant attachment by the wireless terminal to the base station apparatus, to perform an attachment operation to the base station apparatus.

In one example, the method, wherein the processor circuitry is further configured to obtain the quality of service parameter requested for the connection from an application which is executed at the wireless terminal.

In one example, the method, wherein the processor circuitry is further configured: to obtain the quality of service parameter requested for the connection as a requested quality of service value and to receive a broadcasted quality of service value from the broadcasted quality of service information, and to use the requested quality of service value and the broadcasted quality of service value to determine whether to attach to the base station apparatus.

In one example, the method, wherein the processor circuitry is further configured: to receive plural broadcasted quality of service values from the broadcasted quality of service information, and to determine whether the quality of service information broadcasted by the base station apparatus warrants the attachment by the wireless terminal to the base station apparatus by making a favorable comparison of the requested quality of service value with any one of the plural broadcasted quality of service values.

In one example, the method, wherein processor circuitry is configured: to obtain plural requested quality of service values, and to determine whether the quality of service information broadcasted by the base station apparatus warrants the attachment by the wireless terminal to the base station apparatus by making a favorable comparison of any one of the requested quality of service values with any one of the plural broadcasted quality of service values.

In one example, the method, wherein the requested quality of service value and the broadcasted quality of service value are standardized 5QIValues.

In one example, the method, wherein the processor circuitry is further configured: to translate the quality of service parameter requested for the connection into a requested quality of service value and to receive a broadcasted quality of service value from the broadcasted quality of service information, and to use the quality of service information broadcast by the base station apparatus and the quality of the requested service parameter value to determine whether to attach to the base station apparatus.

In one example, the method, wherein the processor circuitry is further configured: to receive plural broadcasted quality of service values from the broadcasted quality of service information, and to determine whether the quality of service information broadcasted by the base station apparatus warrants the attachment by the wireless terminal to the base station apparatus by making a favorable comparison of the requested quality of service value with any one of the plural broadcasted quality of service values.

In one example, the method, wherein processor circuitry is configured: to translate one or more quality of service parameters requested for the connection into plural requested quality of service values, and to determine whether the quality of service information broadcasted by the base station apparatus warrants the attachment by the wireless terminal to the base station apparatus by making a favorable comparison of any one of the requested quality of service values with any one of the plural broadcasted quality of service values.

In one example, the method, wherein the requested quality of service value and the broadcasted quality of service value are standardized 5QIValues.

In one example, the method, wherein the quality of service information broadcast by the base station apparatus comprises an associated area scope parameter, the area scope parameter indicating whether the quality of service indicated by the quality of service information is cell specific or area specific (e.g., uniformly offered at other available base station nodes of the radio access network), and wherein the processor circuitry is further configured, in a case that the quality of service information broadcast by the base station apparatus does not warrant attachment by the wireless terminal to the base station apparatus and the area scope parameter specifies that the quality of service information is cell specific, to select a cell served by another base station apparatus for the attachment.

In one example, the method, wherein the quality of service information broadcast by the base station apparatus comprises an quality of service value, and wherein the quality of service value has the associated area scope parameter.

In one example, the method, wherein the quality of service information broadcast by the base station apparatus comprises plural quality of service values, and wherein each of the plural quality of service values is associated with an area scope parameter.

In one example, a wireless terminal which communicates with a base station apparatus of a radio access network over a radio interface, the wireless terminal comprising: receiver circuitry configured to receive system information broadcast by the base station apparatus; processor circuitry configured to determine from the received system information that the base station apparatus is an Integrated Access and Backhaul (IAB) node and to use the system information to make a determination whether to attach to the base station apparatus.

In one example, the wireless terminal, wherein the received system information comprises quality of service information indicating a quality of service provided by the base station apparatus.

In one example, the wireless terminal, wherein the received system information comprises an indication of whether the received system information is cell specific or network specific.

In one example, a method in a wireless terminal which communicates with a base station apparatus of a radio access network over a radio interface, the wireless terminal comprising: receiving system information broadcast by the base station apparatus; determining from the received system information that the base station apparatus is an Integrated Access and Backhaul (IAB) node and to use the system information to make a determination whether to attach to the base station apparatus.

In one example, the method, wherein the received system information comprises quality of service information indicating a quality of service provided by the base station apparatus.

In one example, the method, wherein the received system information comprises an indication of whether the received system information is cell specific or network specific.

In one example, the base station apparatus, wherein the quality of service information is at least partially based on network linkage remoteness of the base station apparatus relative to a donor Integrated Access and Backhaul (IAB) node.

In one example, the wireless terminal, wherein the quality of service information broadcast by the base station apparatus being dependent on network linkage remoteness of the base station apparatus relative to a donor Integrated Access and Backhaul (IAB) node.

### CROSS REFERENCE

This Nonprovisional application claims priority under 35 U.S.C. § 119 on provisional Application No. 62,817,964 on Mar. 13 2019, the entire contents of which are hereby incorporated by reference.

What is claimed is:

1. A base station apparatus of a radio access network comprising:
processor circuitry configured to provide system information including quality of service information describing a quality of service offered by the base station apparatus;
transmitter circuitry configured to transmit the system information over a radio interface to a wireless terminal to enable the wireless terminal to use the quality of service information to determine whether to attach to the base station apparatus.

2. The base station apparatus of claim 1, wherein the quality of service information is at least partially based on network linkage remoteness of the base station apparatus relative to a donor Integrated Access and Backhaul (IAB) node.

3. The base station apparatus of claim 1, wherein the processor circuitry is configured to provide the system information to include an indication that the base station apparatus is an Integrated Access and Backhaul (IAB) node.

4. (canceled)

5. The base station apparatus of claim 1, wherein the processor circuitry is configured to provide the system information whereby the quality of service information is included in a system information block (SIB) which exclusively includes system information for an Integrated Access and Backhaul (IAB) node.

6. The base station apparatus of claim 1, wherein the processor circuitry is configured to ascertain the network linkage remoteness of the base station apparatus relative to the donor IAB node.

7. The base station apparatus of claim 1, wherein the processor circuitry is configured to provide the system information to include a quality of service value.

8. The base station apparatus of claim 7, wherein the processor circuitry is configured to provide the system information to include an area scope parameter associated with the quality of service value, the area scope parameter indicating whether the quality of service indicated by the quality of service value is cell specific or area specific (e.g., uniformly offered at other available base station nodes of the radio access network).

9. (canceled)

10. A wireless terminal which communicates with a base station apparatus of a radio access network across a radio interface, the wireless terminal comprising:
receiver circuitry configured to obtain quality of service information broadcast by the base station apparatus;
processor circuitry configured:
to obtain a quality of service parameter requested for a connection to the radio access network;
to use the quality of service information broadcast by the base station apparatus and the quality of the service parameter requested for the connection to determine whether to attach to the base station apparatus.

11. The wireless terminal of claim 10, wherein the quality of service information broadcast by the base station apparatus being dependent on network linkage remoteness of the base station apparatus relative to a donor Integrated Access and Backhaul (IAB) node.

12. The wireless terminal of claim 10, wherein the processor circuitry is further configured, in a case that the quality of service information broadcast by the base station apparatus does not warrant attachment by the wireless terminal to the base station apparatus, to select a cell served by another base station apparatus for the attachment.

13. The wireless terminal of claim 10, wherein the processor circuitry is further configured, in a case that the quality of service information broadcast by the base station apparatus does warrant attachment by the wireless terminal to the base station apparatus, to perform an attachment operation to the base station apparatus.

14. The wireless terminal of claim 10, wherein the processor circuitry is further configured to obtain the quality of service parameter requested for the connection from an application which is executed at the wireless terminal.

15. The wireless terminal of claim 10, wherein the processor circuitry is further configured:
to obtain the quality of service parameter requested for the connection as a requested quality of service value and to receive a broadcasted quality of service value from the broadcasted quality of service information, and
to use the requested quality of service value and the broadcasted quality of service value to determine whether to attach to the base station apparatus.

16. (canceled)

17. The wireless terminal of claim 10, wherein the quality of service information broadcast by the base station apparatus comprises an associated area scope parameter, the area scope parameter indicating whether the quality of service indicated by the quality of service information is cell specific or area specific (e.g., uniformly offered at other available base station nodes of the radio access network), and wherein the processor circuitry is further configured, in a case that the quality of service information broadcast by the base station apparatus does not warrant attachment by the wireless terminal to the base station apparatus and the area scope parameter specifies that the quality of service information is cell specific, to select a cell served by another base station apparatus for the attachment.

18. The wireless terminal of claim 17, wherein the quality of service information broadcast by the base station apparatus comprises an quality of service value, and wherein the quality of service value has the associated area scope parameter.

19. (canceled)
